(19) United States
(12) Patent Application Publication
(10) Pub. No.: US 2013/0129465 A1
(43) Pub. Date: May 23, 2013

(54) ELECTROCONDUCTIVE LAYER-TRANSFERRING MATERIAL AND TOUCH PANEL

(71) Applicant: Fujifilm Corporation, Tokyo (JP)

(72) Inventors: Kentaro OKAZAKI, Ashigarakami-gun (JP); Yuki MATSUNAMI, Ashigarakami-gun (JP); Fumio OBATA, Ashigarakami-gun (JP); Kenji NAOI, Ashigarakami-gun (JP); Shinichi NAKAHIRA, Ashigarakami-gun (JP)

(73) Assignee: FUJIFILM CORPORATION, Tokyo (JP)

(21) Appl. No.: 13/731,987

(22) Filed: Dec. 31, 2012

Related U.S. Application Data
(63) Continuation of application No. PCT/JP2011/064701, filed on Jun. 27, 2011.

(30) Foreign Application Priority Data
Jul. 2, 2010 (JP) 2010-152042

(51) Int. Cl. H01B 1/00

(52) U.S. Cl. CPC H01B 1/00
USPC 414/800; 428/216

(57) ABSTRACT

An electroconductive layer-transferring material including: a base material; a cushion layer on the base material; and an electroconductive layer on the cushion layer, the electroconductive layer containing metal nanowires having an average minor axis length of 100 nm or less and an average major axis length of 2 μm or more, wherein the electroconductive layer-transferring material satisfies A/B=0.1 to 0.7, where A is a total thickness of an average thickness of the electroconductive layer and an average thickness of the cushion layer, and B is an average thickness of the base material, wherein the average thickness of the electroconductive layer is 0.01 μm to 0.2 μm, and wherein the average thickness of the cushion layer is 1 μm to 50 μm.

### CROSS-REFERENCE TO RELATED APPLICATION

This is a continuation application of PCT/JP2011/064701, filed on Jun. 27, 2011.

### BACKGROUND OF THE INVENTION

1. Field of the Invention

The present invention relates to an electroconductive layer-transferring material and a touch panel.

2. Description of the Related Art

In recent years, touch panels have been incorporated as input devices into display devices such as liquid crystal panels and electronic paper. In capacitive touch panels, they use two or more transparent glass plates each provided with ITO (Indium Tin Oxide) and the yield in lamination of them becomes low. Thus, there is a demand to reduce the number of parts to make the thickness of the touch panel smaller. There also is another demand to reduce the number of materials used to achieve cost reduction. Therefore, on-cell touch panels have been disclosed in which an ITO transparent electroconductive material is laminated on a surface of a liquid crystal cell. However, this literature discloses only a configuration where ITO is used as a transparent electroconductive film, making it difficult to obtain a light, thin touch panel due to increase in the number of parts.

Japanese Patent Application Laid-Open (JP-A) No. 2006-35771 has proposed an electroconductive layer-transferring material having an electroconductive layer containing carbon nanotubes as metal nanowires. However, the proposed electroconductive layer containing metal nanowires generally has a thickness of as small as 0.01 μm to 2 μm and is degraded in adhesiveness to a transfer target to raise a problem that uniform transfer cannot be performed.

Also, there has been proposed an electroconductive transfer film where an electroconductive layer and a photosensitive resin layer are sequentially laminated on a temporal support (see JP-A No. 2010-251186). This proposal describes an ITO transparent electroconductive film as the electroconductive layer and discloses patterning the electroconductive layer through photolithography. In this proposal, however, the electroconductive layer and the photosensitive resin layer are separate layers. In this structure, the electroconductive layer cannot have an electrical contact with the electrode on the glass substrate, which imposes limitation on use thereof.

Meanwhile, when the electroconductive layer serves also as the photosensitive resin layer, it is possible for the electroconductive layer to have an electrical contact with the electrode on the glass substrate. When the electroconductive layer is thin, the electroconductive layer cannot successfully follow the electrode and possible concave/convex portions on the glass substrate at positions where it is across them, causing disconnection.

### SUMMARY OF THE INVENTION

The present invention aims to solve the above existing problems and achieve the following objects. Specifically, an object of the present invention is to provide: an electroconductive layer-transferring material excellent in transferability and adhesiveness to a transfer target and improved in uniform transfer and followability to concave/convex portions of an electroconductive layer; and a touch panel containing an electroconductive layer transferred from the electroconductive layer-transferring material and having a less number of parts and being light and thin.

The present inventors conducted extensive studies to solve the above existing problems and have found that by providing a cushion layer between an electroconductive layer containing metal nanowires and a base material where a total thickness A of an average thickness of the electroconductive layer and an average thickness of the cushion layer and an average thickness B of the base material satisfy the expression: A/B=0.1 to 0.7, and the average thickness of the electroconductive layer is 0.01 μm to 0.2 μm and the average thickness of the cushion layer is 1 μm to 50 μm, the electroconductive layer is improved in uniform transfer and followability to concave/convex portions to be excellent in transferability and adhesiveness to a transfer target (i.e., an object to which the electroconductive layer is to be transferred), whereby the electroconductive layer (transparent electroconductive film) is transferred to a glass substrate efficiently, and a touch panel that can be made light and thin and be combined together with a liquid crystal cell.

The present invention is based on the above finding obtained by the present inventors, and means for solving the problems are as follows.

<1> An electroconductive layer-transferring material including:

a base material;

a cushion layer on the base material; and

an electroconductive layer on the cushion layer,

the electroconductive layer containing metal nanowires having an average minor axis length of 100 nm or less and an average major axis length of 2 μm or more,

wherein the electroconductive layer-transferring material satisfies A/B=0.1 to 0.7, where A is a total thickness of an average thickness of the electroconductive layer and an average thickness of the cushion layer, and B is an average thickness of the base material,

wherein the average thickness of the electroconductive layer is 0.01 μm to 0.2 μm, and

wherein the average thickness of the cushion layer is 1 μm to 50 μm.

<2> The electroconductive layer-transferring material according to <1>,

wherein the average thickness of the electroconductive layer is 0.05 μm to 0.15 μm.

<3> The electroconductive layer-transferring material according to <1> or

<2>, wherein the average thickness of the cushion layer is 5 μm to 20 μm.

<4> The electroconductive layer-transferring material according to any one of <1> to <3>, wherein the electroconductive layer has a change in resistance of 0% to 50%, where the change in resistance is calculated by {(Y−X)/X}×100 where X is a resistance of the electroconductive layer before drawing of the electroconductive layer and Y is a resistance of the electroconductive layer after tensile drawing of the electroconductive layer in a horizontal direction at a draw ratio of 2%.

<5> The electroconductive layer-transferring material according to any one of <1> to <3>, wherein the electroconductive layer has a change in resistance of 0% to 100%, where the change in resistance is calculated by {(Z−X)/X}×100 where X is a resistance of the electroconductive layer before drawing of the electroconductive layer and Z is a resistance of the electroconductive layer after tensile drawing of the electroconductive layer in a horizontal direction at a draw ratio of 5%.

<6> The electroconductive layer-transferring material according to any one of <1> to <5>, wherein the electroconductive layer has a melt viscosity at 110° C. of 500 Pa·s to 2,000,000 Pa·s.

<7> The electroconductive layer-transferring material according to <6>, wherein the electroconductive layer has a melt viscosity at 110° C. of 1,000 Pa·s to 1,000,000 Pa·s.

<8> The electroconductive layer-transferring material according to any one of <1> to <7>, wherein the electroconductive layer has a mass ratio a/b of 0.1 to 5, where “a” is a mass of other ingredients than the metal nanowires in the electroconductive layer and “b” is a mass of the metal nanowires in the electroconductive layer.

<9> The electroconductive layer-transferring material according to any one of <1> to <8>, wherein the metal nanowires are formed of silver or formed of an alloy formed between silver and a metal other than silver.

<10> The electroconductive layer-transferring material according to any one of <1> to <9>, wherein the electroconductive layer has a total visible light transmittance of 85% or more.

<11> The electroconductive layer-transferring material according to any one of <1> to <10>, wherein the electroconductive layer has a surface resistance of 0.1 Ω/sq. to 5,000 Ω/sq.

<12> The electroconductive layer-transferring material according to any one of <1> to <11>, further including an adhesion layer on the electroconductive layer.

<13> A liquid crystal display device or a touch panel including:

an electroconductive layer,

wherein the electroconductive layer is transferred from the electroconductive layer-transferring material according to any one of <1> to <12>.

<14> A method for transferring an electroconductive layer, the method including:

transferring the electroconductive layer of the electroconductive layer-transferring material according to any one of <1> to <12> to a transfer target having concave and convex portions at a transfer speed of 0.5 cm/sec to 10 cm/sec.

The present invention can provide an electroconductive layer-transferring material excellent in transferability and adhesiveness to a transfer target and improved in uniform transfer and followability to concave/convex portions of an electroconductive layer; and a touch panel containing an electroconductive layer transferred from the electroconductive layer-transferring material and having a less number of parts and being light and thin. These can solve the above existing problems.

### BRIEF DESCRIPTION OF THE DRAWINGS

FIG. 1 is a schematic view of one exemplary electroconductive layer-transferring material of the present invention.

FIG. 2 is a schematic view of another exemplary electroconductive layer-transferring material of the present invention.

FIGS. 3A to 3C illustrate a transfer method using an electroconductive layer-transferring material of the present invention.

FIG. 4 is a schematic, cross-sectional view of one exemplary touch panel.

FIG. 5 is a schematic, explanatory view of another exemplary touch panel.

FIG. 6 is a schematic, plan view of one exemplary arrangement of electroconductors in the touch panel illustrated in FIG. 5.

FIG. 7 is a schematic, cross-sectional view of still another exemplary touch panel.

FIG. 8 is an explanatory view of a measurement method for a change in resistance in an electroconductive layer which is across a convex portion of a glass substrate.

### DETAILED DESCRIPTION OF THE INVENTION

### Electroconductive Layer-Transferring Material

An electroconductive layer-transferring material of the present invention contains: a base material; a cushion layer on the base material; and an electroconductive layer containing metal nanowires, the electroconductive layer being on the cushion layer; and, if necessary, further contains other layers.

In the present invention, the electroconductive layer-transferring material satisfies A/B=0.1 to 0.7, preferably A/B=0.2 to 0.6, where A is a total thickness of an average thickness of the electroconductive layer and an average thickness of the cushion layer, and B is an average thickness of the base material. When the ratio A/B is less than 0.1, uniform transfer onto a transfer target and followability to concave/convex portions may be degraded. Whereas when it is more than 0.7, curling balance may be impaired.

The average thickness of the base material is not particularly limited and may be appropriately selected depending on the intended purpose, but is preferably 1 μm to 500 μm, more preferably 3 μm to 400 μm, further preferably 5 μm to 300 μm.

When the average thickness of the base material is smaller than 1 μm, the electroconductive layer-transferring material may be difficult to handle. Whereas when it is larger than 500 μm, the base material is increased in rigidity, so that uniform transfer may be degraded.

The average thickness of the electroconductive layer is 0.01 μm to 0.2 μm, preferably 0.05 μm to 0.15 μm. When the average thickness of the electroconductive layer is smaller than 0.01 μm, distribution of electroconductivity in the layer surface may be ununiform. Whereas when it is larger than 0.2 μm, transmittance decreases and as a result transparency may be degraded.

The average thickness of the cushion layer is 1 μm to 50 μm, preferably 5 μm to 20 μm. When the average thickness of the cushion layer is smaller than 1 μm, uniform transfer onto a transfer target and followability to concave/convex portions may be degraded. Whereas when it is larger than 50 μm, the curling balance of electroconductive layer-transferring material may be impaired.

Here, the average thickness of the base material, the average thickness of the electroconductive layer, and the average thickness of the cushion layer can be measured as follows, for example. Specifically, the electroconductive layer-transferring material is cut with a microtome to expose their cross-sections, and the exposed cross-sections are observed under an SEM. Alternatively, the electroconductive layer-transferring material is wrapped with an epoxy resin and then cut with a microtome to prepare its cut section, and the cut section is observed under a TEM. The average thickness of each of the base material, the electroconductive layer and the cushion layer is an average of 10 values measured at points therein.

The shape, structure and size of the electroconductive layer-transferring material of the present invention are not particularly limited, so long as it has the above-described configuration, and may be appropriately selected depending on the intended purpose. Examples of the shape include a film and a sheet. Examples of the structure include a monolayer structure and a laminated structure. The size may be appropriately selected depending on the intended application.

The electroconductive layer-transferring material is flexible, and preferably is transparent. The term “transparent” encompasses colorless and transparent, colored and transparent, semitransparent, and colored and semitransparent.

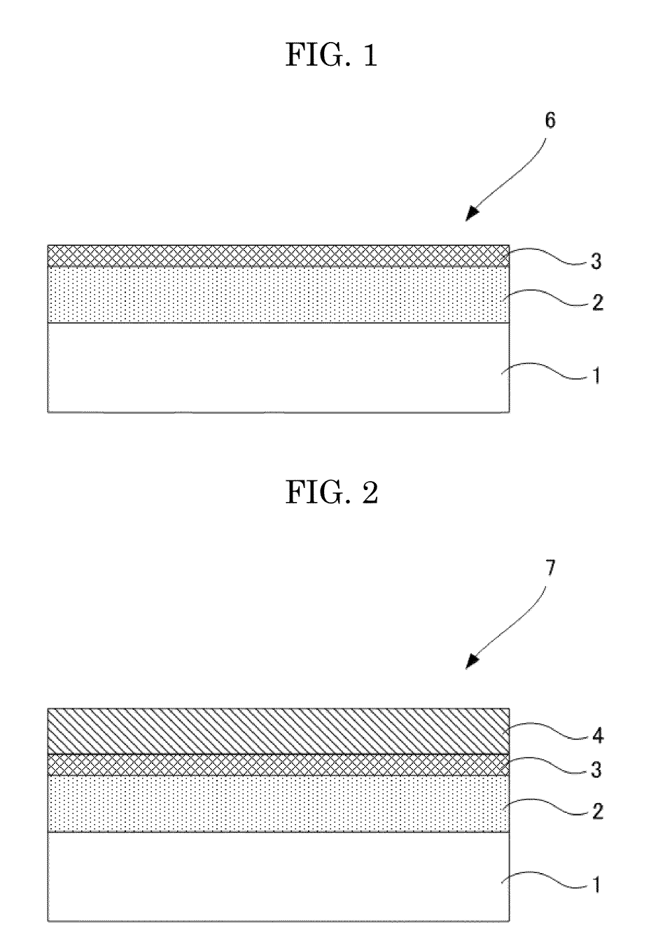

Here, FIG. 1 is a schematic view of one example of the electroconductive layer-transferring material of the present invention. An electroconductive layer-transferring material 6 illustrated in FIG. 1 contains a base material 1, a cushion layer 2 and an electroconductive layer 3, the cushion layer 2 and the electroconductive layer 3 being on one surface of the base material in this order.

FIG. 2 is a schematic view of another example of the electroconductive layer-transferring material of the present invention. An electroconductive layer-transferring material 7 illustrated in FIG. 2 is the same as the electroconductive layer-transferring material 6 illustrated in FIG. 1 except that an adhesion layer 4 is on the electroconductive layer 3.

Notably, the electroconductive layer 3 of the electroconductive layer-transferring material may be or may not be patterned, although a patterned electroconductive layer is not illustrated. The pattern on the electroconductive layer is, for example, electrode patterns formed on existing ITO transparent electroconductive films. Specific examples include striped patterns and patterns called diamond pattern disclosed in International Publication Nos. WO2005/114369 and 2004/061808 and JP-A Nos. 2010-33478 and 2010-44453.

### <Base Material>

The shape, structure and size of the base material are not particularly limited and may be appropriately selected depending on the intended purpose.

Examples of the shape include a film and a sheet. Examples of the structure include a monolayer structure and a laminated structure. The size may be appropriately selected depending on the intended application.

After the electroconductive layer-transferring material has been transferred onto the transfer target, the base material is peeled off and the cushion layer and the electroconductive layer are transferred onto the transfer target.

The base material is not particularly limited and may be appropriately selected depending on the intended purpose. Examples thereof include transparent glass substrates, synthetic resin sheets (films), metal substrates, ceramic plates and semiconductor substrates having photoelectric conversion elements. These substrates may be pre-treated, as desired, through, for example, a chemical treatment using a silane coupling agent, a plasma treatment, ion plating, sputtering, a vapor phase reaction method, and vacuum vapor deposition.

Examples of the transparent glass substrates include white plate glasses, blue plate glasses and silica-coated blue glasses. Also, a recently-developed thin glass base 10 μm to several hundreds micrometers in thickness may be used as the base material.

Examples of the synthetic resin sheets include those made of, for example, polyethylene terephthalate (PET) sheets, polycarbonate sheets, triacetyl cellulose (TAC) sheets, polyethersulfone sheets, polyester sheets, acrylic resin sheets, vinyl chloride resin sheets, aromatic polyamide resin sheets, polyamideimide sheets and polyimide sheets.

Examples of the metal substrates include aluminum plates, copper plates, nickel plates and stainless steel plates.

The base material preferably has a total visible light transmittance of 70% or higher, more preferably 85% or higher, further preferably 90% or higher. When the total visible light transmittance is lower than 70%, the transmittance of the base material is low, which may be problematic in practical use.

Notably, in the present invention, the base material may also be a colored base material which is colored to such an extent that the effects of the present invention are not impeded.

### <Cushion Layer>

The cushion layer prevents discontinuation of the electroconductive layer even when the electroconductive layer covers concave and convex portions of the base material, improving its followability to concave/convex portions.

The shape, structure and size of the cushion layer are not particularly limited and may be appropriately selected depending on the intended purpose. Examples of the shape include a film and a sheet. Examples of the structure include a monolayer structure and a laminated structure. The size may be appropriately selected depending on the intended application.

The cushion layer is a layer that plays a role of improving transferability onto the transfer target and contains at least a polymer; and, if necessary, further contains other ingredients.

### —Polymer—

The polymer is not particularly limited and may be appropriately selected depending on the intended purpose so long as it softens upon heating. Examples thereof include thermoplastic resins. Examples of the thermoplastic resins include acryl resins, styrene-acryl copolymers, polyvinyl alcohols, polyethylenes, ethylene-vinyl acetate copolymers, ethylene-ethyl acrylate copolymers, ethylene-methacrylic acid copolymers, polyvinyl chloride gelatine; cellulose esters such as cellulose nitrate, cellulose acetate, cellulose diacetate, cellulose acetate butyrate and cellulose acetate propionate; homopolymers or copolymers containing vinylidene chloride, vinyl chloride, styrene, acrylonitrile, vinyl acetate, alkyl (C1 to C4) acrylates and/or vinyl pyrrolidone; soluble polyesters, polycarbonates and soluble polyamides. These may be used alone or in combination.

The glass transition temperature of the cushion layer is preferably 40° C. to 150° C., more preferably 90° C. to 120° C. When the glass transition temperature is lower than 40° C., the cushion layer is so soft at room temperature that its handleability may be poor. Whereas when it is higher than 150° C., the cushion layer is not softened through thermal laminatation, so that the transferability of the electroconductive layer may be degraded. Notably, a plasticizing agent may be added to adjust the glass transition temperature.

Examples of the other ingredients include organic polymer compounds described in paragraph [0007] and the subsequent paragraphs of JP-A No. 05-72724, various kinds of plasticizers for adjusting the adhesiveness to the base material, supercooling compounds, adhesiveness improving agents, fillers, anti-oxidants, surfactants, releasing agents, thermal polymerization inhibitors, viscosity adjusters and solvents.

The cushion layer can be formed by coating the base material with a cushion layer-coating liquid containing the polymer and the other ingredients used if necessary, followed by drying.

The method for the coating is not particularly limited and may be appropriately selected depending on the intended purpose. Examples thereof include a roll coat method, a bar coat method, a dip coating method, a spin coating method, a casting method, a die coat method, a blade coat method, a gravure coat method, a curtain coat method, a spray coat method and a doctor coat method.

### <Electroconductive Layer>

The shape, structure and size of the electroconductive layer are not particularly limited and may be appropriately selected depending on the intended purpose. Examples of the shape include a film and a sheet. Examples of the structure include a monolayer structure and a laminated structure. The size may be appropriately selected depending on the intended application.

The electroconductive layer contains at least metal nanowires; and, if necessary, further contains a binder, a photosensitive compound and other ingredients.

### <<Metal Nanowire>>

### —Material—

The material of the metal nanowire is not particularly limited and may be appropriately selected depending on the intended purpose. For example, the material is preferably at least one metal selected from the 4^{th}, 5^{th} and 6^{th} periods of the long form of Periodic Table (IUPAC 1991), more preferably at least one metal selected from the 2^{nd} to 14^{th} groups thereof, yet more preferably at least one metal selected from the 2^{nd} group, the 8^{th} group, 9^{th} group, 10^{th} group, 11^{th} group, 12^{th} group, 13^{th} group and 14^{th} group thereof. Moreover, it is particularly preferred that the above at least one metal be contained in the material as a main component.

### —Metal—

Examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead or alloys thereof. Among them, silver, and alloys formed between silver and a metal(s) other than silver are particularly preferred, since they are excellent in electroconductivity.

Examples of the metal(s) other than silver include platinum, osmium, palladium, and iridium. These may be used alone or in combination.

### —Shape—

The shape of each of the metal nanowires is not particularly limited and may be appropriately selected depending on the intended purpose. For example, the metal nanowire may have any shape such as a cylindrical columnar shape, a rectangular parallelepiped shape, and a columnar shape with a polygonal cross-section. When high transparency is required in use, the metal nanowire preferably has a cylindrical columnar shape or a polygonal cross-section whose corners are rounded.

The shape of the cross-section of the metal nanowire may be confirmed as follows. Specifically, an aqueous dispersion of the metal nanowires is coated onto a base material, and their cross-sections are observed under a transmission electron microscope (TEM).

### —Average Minor Axis Length and Average Major Axis Length—

The average minor axis length (hereinafter may be referred to as “average minor axis diameter” or “average diameter”) of the metal nanowires is 100 nm or less, preferably 1 nm to 50 nm, more preferably 10 nm to 40 nm, further preferably 15 nm to 35 nm.

When the average minor axis length thereof is less than 1 nm, the metal nanowires may be decreased in oxidation resistance and hence degraded in durability. Whereas when the average minor axis length thereof is more than 100 nm, scattering due to the metal nanowires occurs, resulting in that satisfactory transparency cannot be obtained in some cases.

The average minor axis length of the metal nanowires is measured with a transmission electron microscope (TEM) (product of JEOL Ltd., JEM-2000FX). Specifically, 300 metal nanowires are observed under the transmission electron microscope. Based on the average values obtained from the observation, the average minor axis length of the metal nanowires is obtained. Notably, when the cross-sectional shape of the metal nanowire in the direction along the minor axis thereof is not circular, the minor axis length thereof is defined as the longest length thereof.

The average major axis length of the metal nanowires (hereinafter may be referred to as “average length”) is 2 μm or more, preferably 2 μm to 40 μm, more preferably 3 μm to 35 μm, further preferably 5 μm to 30 μm.

When the average major axis length is less than 2 μm, the metal nanowires are difficult to form a dense network and thus cannot be achieve sufficient electroconductivity in some cases. When the average major axis length is more than 40 μm, the metal nanowires may tangle with each other due to its too long length, resulting in forming aggregates in a manufacturing process.

The average major axis length of the metal nanowires is measured with a transmission electron microscope (TEM) (product of JEOL Ltd., JEM-2000FX). Specifically, 300 metal nanowires are observed under the transmission electron microscope. Based on the average values obtained from the observation, the average major axis length of the metal nanowires is obtained. Notably, when the metal nanowire is curved, the major axis length of the curved metal nanowire is defined as a value calculated from the radius and curvature of a circle drawn from the curved metal nanowire as an arc.

### —Production Method—

The production method for the metal nanowires is not particularly limited and may be any production method. Preferably, as described below, the metal nanowires are produced by reducing metal ions under heating in a solvent containing a halogen compound and a dispersing additive dissolved therein.

The metal nanowire can be produced using, for example, the methods described in JP-A Nos. 2009-215594, 2009-242880, 2009-299162, 2010-84173, and 2010-86714.

The solvent is preferably a hydrophilic solvent. Examples of the hydrophilic solvent include water, alcohols, ethers and ketones. These may be used alone or in combination.

Examples of the alcohols include methanol, ethanol, propanol, isopropanol, butanol and ethylene glycol.

Examples of the ethers include dioxane and tetrahydrofuran.

Examples of the ketones include acetone.

The heating temperature for the above heating is preferably 250° C. or lower, more preferably 20° C. to 200° C., yet more preferably 30° C. to 180° C., particularly preferably 40° C. to 170° C.

When the heating temperature is lower than 20° C., the formed metal nanowires become too long since the yield of core formation is lowered. Thus, these metal nanowires tend to be tangled each other, potentially leading to degradation of dispersion stability. Whereas when the heating temperature is higher than 250° C., the angles of the cross sections of the formed metal nanowires become sharp and thus, the transmittance of the coated film formed therefrom may be lowered.

If necessary, the temperature may be changed during the formation of metal nanowires. To change the temperature in the course of the formation may contribute to the control for formation of the core of the metal nanowires, to the prevention of generation of re-grown cores, and to the promotion of selective growth to improve the monodispersibility.

It is preferred that the reducing agent be added at the time of the heating.

The reducing agent is not particularly limited and may be appropriately selected from commonly-used reducing agents. Examples of the reducing agent include metal salts of boron hydrides, aluminum hydride salts, alkanol amines, aliphatic amines, heterocyclic amines, aromatic amines, aralkyl amines, alcohols, organic acids, reducing sugars, sugar alcohols, sodium sulfite, hydrazine compounds, dextrins, hydroquinones, hydroxylamines, ethylene glycol and glutathione. Among them, the reducing sugars, sugar alcohols that are derivatives of the reducing sugars, and ethylene glycol are particularly preferred.

Examples of the metal salts of boron hydrides include sodium boron hydride and potassium boron hydride.

Examples of the aluminum hydride salts include lithium aluminum hydride, potassium aluminum hydride, cesium aluminum hydride, beryllium aluminum hydride, magnesium aluminum hydride and calcium aluminum hydride.

Examples of the alkanol amines include diethylamino ethanol, ethanol amine, propanol amine, triethanol amine and dimethylamino propanol.

Examples of the aliphatic amines include propyl amine, butyl amine, dipropylene triamine, ethylene diamine and tetraethylenepentamine.

Examples of the heterocyclic amines include piperidine, pyrrolidine, N-methylpyrrolidine and morpholine.

Examples of the aromatic amines include aniline, N-methyl aniline, toluidine, anisidine and phenetidine.

Examples of the aralkyl amines include benzyl amine, xylene diamine and N-methylbenzyl amine.

Examples of the alcohols include methanol, ethanol and 2-propanol.

Examples of the organic acids include citric acid, malic acid, tartaric acid, succinic acid, ascorbic acid or salts thereof.

Examples of the reducing sugars include glucose, galactose, mannose, fructose, sucrose, maltose, raffinose and stachyose.

Examples of the sugar alcohols include sorbitol.

Note that, there is a case where the reducing agents may also function as a dispersing additive or a solvent depending on the types of the reducing agents, and those reducing agents are also preferably used in the present invention.

The metal nanowires are preferably produced through addition of a dispersing additive and a halogen compound or metal halide fine particles.

The timing when the dispersing additive and halogen compound are added may be before or after addition of the reducing agent, and may be before or after addition of the metal ions or metal halide fine particles. For producing nanowires having better monodispersibility, the halogen compound is preferably added twice or more times in a divided manner.

The dispersing additive is not particularly limited and may be appropriately selected depending on the intended purpose. Examples of the dispersing additive include amino group-containing compounds, thiol group-containing compounds, sulfide group-containing compounds, amino acids or derivatives thereof, peptide compounds, polysaccharides, synthetic polymers, and gels derived from those mentioned above. Among them, particularly preferred are gelatin, polyvinyl alcohol, methyl cellulose, hydroxypropyl cellulose, polyalkylene amine, partial alkyl ester of polyacrylic acid, polyvinyl pyrrolidone and polyvinyl-pyrrolidine copolymer.

The structures usable for the dispersing additive can be, for example, referred to the description in “Pigment Dictionary” (edited by Seishiro Ito, published by ASAKURA PUBLISHING CO., 2000).

Depending on the type of the dispersing additive used, the shapes of metal nanowires obtained can be changed.

The halogen compound is not particularly limited, so long as it contains bromine, chlorine or iodine, and may be appropriately selected depending on the intended purpose. Preferable examples of the halogen compound include alkali halides such as sodium bromide, sodium chloride, sodium iodide, potassium iodide, potassium bromide and potassium chloride; and compounds that can be used in combination with the below-described dispersing agent.

Note that, there may be a case where the halogen compounds may also function as a dispersing additive depending on the types of the halogen compounds, and those halogen compounds are also preferably used.

Silver halide fine particles may be used instead of the halogen compound, or the halogen compound and the silver halide fine particles may be used in combination.

A single compound having the functions of both the dispersing agent and the halogen compound may be used. Examples of the compound having the functions of both the dispersing agent and the halogen compound include: hexadecyl-trimethylammonium bromide (HTAB) containing an amino group and a bromide ion; hexadecyl-trimethylammonium chloride (HTAC) containing an amino group and a chloride ion; and dodecytrimethylammonium bromide, dodecytrimethylammonium chloride, stearyltrimethylammonium bromide, stearyltrimethylammonium chloride, decyltrimethylammonium bromide, decyltrimethylammonium chloride, dimethyldistearylammonium bromide, dimethyldistearylammonium chloride, dilauryldimethylammonium bromide, dilauryldimethylammonium chloride, dimethyldipalmitylammonium bromide and dimethyldipalmitylammonium chloride each containing an amino group and a bromide or chloride ion.

The demineralizing treatment can be performed after formation of the metal nanowires through, for example, ultrafiltration, dialysis, gel filtration, decantation or centrifugation.

### —Aspect Ratio—

An aspect ration of the metal nanowires is preferably 10 or more. The term “aspect ratio” generally means a ratio of the long side length and the short side length (average major axis length/average minor axis length) of fibrous material.

A method for measuring the aspect ratio is not particularly limited and may be appropriately selected depending on the intended purpose. For example, the aspect ratio can be measured with an electron microscope.

When the aspect ratio is measured with an electron microscope, whether the aspect ratio of the metal nanowires is 10 or more can be judged by observing only one visual field of the electron microscope. Alternatively, the aspect ratio of the metal nanowires can be entirely estimated by separately measuring the long side length and the short side length of each of the metal nanowires.

The aspect ratio of the metal nanowires is not particularly limited, so long as it is 10 or more, and may be appropriately selected depending on the intended purpose, but is preferably 50 to 1,000,000, more preferably 100 to 1,000,000.

When the aspect ratio is less than 10, the metal nanowires may not form the network resulting in insufficient electroconductivity. When the aspect ratio is more than 1,000,000, a stable solution of the metal nanowires cannot be obtained in some cases because the metal nanowires may tangle with each other to form aggregates at the formation of the metal nanowires, during subsequent handling and/or before film formation.

### —Ratio of Metal Nanowires Having Aspect Ratio of 10 or More—

A ratio of the metal nanowires having an aspect ratio of 10 or more is preferably 50% by volume or more, more preferably 60% by volume or more, particularly preferably 75% by volume or more relative to the total electroconductive composition. The above percentage of the metal nanowires hereinafter may be referred to as “ratio of metal nanowires.”

When the ratio of the metal nanowires is less than 50% by volume, an electroconductive material which contributes to the electroconductivity decreases, potentially leading to low electroconductivity. In addition, the metal nanowires may not form a dense network resulting in the voltage concentration, which may deteriorate the durability. Particles other than the metal nanowires are not preferred in that they do not highly contribute to the electroconductivity and do exhibit unwanted absorption at some wavelengths. Especially in the case of the metal, the spherical particles exhibiting strong plasmon absorption may deteriorate the transparency.

The ratio of the metal nanowires is measured as follows, for example, in the case where the metal nanowires are silver nanowires. First, a silver nanowire aqueous dispersion is filtrated to separate the silver nanowires from the other particles. Then, the amount of silver remaining on the filter paper and the amount of silver passing through the filter paper are respectively measured by means of ICP atomic emission spectrometer. Thereafter, the silver nanowires remaining on the filter paper are observed under a transmission electron microscope (TEM), and 300 silver nanowires are measured for minor axis length. From the measurement results, their distribution is examined to confirm that the silver nanowires have the average minor axis length of 200 nm or less and the average major axis length of 1 μm or more. Notably, as the filter paper, those having a pore size which is twice or more of the maximum major axis length of particles other than the silver nanowires having the minor axis length of 200 nm or less and the major axis length of 1 μm or more measured in a TEM image, and which is equal to or less than the minimum major axis length of the silver nanowires are preferably used.

The average minor axis length and the average major axis length of the metal nanowires can be measured by observing the metal nanowires with, for example, a transmission electron microscope (TEM) or an optical microscope. In the present invention, 300 metal nanowires are observed under a transmission electron microscope (TEM). Based on the average values obtained from the observation, the average minor axis length and the average major axis length of the metal nanowires are determined.

Hereinafter, a description is given to an electroconductive layer containing both metal nanowires and a binder (photosensitive resin). However, a photosensitive layer (patterning material) containing a photosensitive resin is not necessarily combined with an electroconductive layer containing metal nanowires to form a single layer. Instead, an electroconductive layer and a photosensitive layer (patterning layer) may be laminated on top of each other. Alternatively, after an electroconductive layer has been transferred onto a transfer target, a photosensitive layer (patterning layer) may be transferred and laminated on the transfer target. Or, a mask for patterning may be formed by screen printing a resist material.

### <<Binder>>

The binder is an organic high-molecular-weight polymer. It is appropriately selected from alkali-soluble resins having a molecular structure (preferably, a molecule containing an acryl copolymer as a main chain) and containing, in the molecular structure, at least one group that promotes alkali solubility (e.g., a carboxyl group, a phosphoric acid group and a sulfonic acid group).

Among them, preferred are alkali-soluble resins that are soluble to organic solvents and can be developed by a weakly alkaline aqueous solution. Particularly preferred are alkali-soluble resins that have a group to be dissociated by an acid and become alkali-soluble when this group is dissociated by the action of an acid.

Here, the group to be dissociated by an acid refers to a functional group that can be dissociated in the presence of an acid.

The binder can be produced by, for example, a known radical polymerization method. When the alkali-soluble resins are produced by the radical polymerization method, polymerization conditions such as temperature, pressure, type and amount of a radical initiator, and type of a solvent can be readily set by those skilled in the art and can be experimentally determined.

The organic high-molecular-weight polymer is preferably a polymer containing a carboxylic acid in a side chain thereof (i.e., a photosensitive resin containing an acid group).

Examples of the polymer containing a carboxylic acid in a side chain thereof include methacrylic acid copolymers, acrylic acid copolymers, itaconic acid copolymers, crotonic acid copolymers, maleic acid copolymers, partially esterified maleic acid copolymers, acid cellulose derivatives containing carboxylic acid in side chains thereof, and addition products obtained by adding acid anhydrides to hydroxyl group-containing polymers, which are described in the following documents: JP-A No. 59-44615, Japanese Patent Application Publication (JP-B) Nos. 54-34327, 58-12577 and 54-25957, and JP-A Nos. 59-53836 and 59-71048. In addition, high-molecular-weight polymers containing a (meth)acryloyl group in side chains thereof are exemplified as a preferred polymer.

Among them, particularly preferred are benzyl(meth)acrylate/(meth)acrylic acid copolymers, and multi-component copolymers of benzyl(meth)acrylate/(meth)acrylic acid/other monomers.

In addition, high-molecular-weight polymers containing a (meth)acryloyl group in side chains thereof, and multi-component copolymers of (meth)acrylic acid/glycidyl (meth)acrylate/other monomers are exemplified as useful polymers. These polymers may be used in combination at any mixing ratio.

Besides the above polymers, the following polymers described in JP-A No. 07-140654 are also exemplified: 2-hydroxypropyl(meth)acrylate/polystyrenemacromonomer/benzyl methacrylate/methacrylic acid copolymers, 2-hydroxy-3-phenoxypropyl acrylate/polymethyl methacylate macromonomer/benzyl methacylate/methacrylic acid copolymers, 2-hydroxyethyl methacylate/polystyrene macromonomer/methyl methacrylate/methacylic acid copolymers, and 2-hydroxyethyl methacrylate/polystyrene macromonomer/benzyl methacrylate/methacylic acid copolymers.

Specific structural units in the alkali-soluble resins are preferably (meth)acrylic acid and other monomers copolymerizable with the (meth)acrylic acid.

Examples of the other monomers copolymerizable with the (meth)acrylic acid include alkyl (meth)acrylates, aryl (meth)acrylates and vinyl compounds. Hydrogen atoms of the alkyl groups and aryl groups thereof may be substituted with substituents.

Examples of the alkyl (meth)acrylates or aryl (meth)acrylates include methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, phenyl (meth)acrylate, benzyl (meth)acrylate, tolyl (meth)acrylate, naphthyl (meth)acrylate, cyclohexyl (meth)acrylate, dicyclopentanyl (meth)acrylate, dicyclopentenyl (meth)acrylate and dicyclopentenyloxyethyl (meth)acrylate. These may be used alone or in combination.

Examples of the vinyl compounds include styrene, α-methylstyrene, vinyltoluene, glycidyl methacrylate, acrylonitrile, vinyl acetate, N-vinyl pyrrolidone, tetrahydrofurfuryl methacrylate, polystyrene macromonomer, polymethyl methacrylate macromonomer, CH₂═CR¹R² and CH₂═C(R¹)(COOR³) (where R¹ is a hydrogen atom or a C1-C5 alkyl group, R² is a C6-C10 aromatic hydrocarbon ring, R³ is a C1-C8 alkyl group or a C6-C12 aralkyl group). These may be used alone or in combination.

The weight average molecular weight of the binder is preferably 1,000 to 500,000, more preferably 3,000 to 300,000, further preferably 5,000 to 200,000, from the viewpoints of dissolution rate to alkali and film properties.

Here, the weight average molecular weight can be measured by a gel permeation chromatography method based on a calibration curve of standard polystyrenes.

The amount of the binder is preferably 25% by mass to 80% by mass, more preferably 30% by mass to 75% by mass, further preferably 40% by mass to 70% by mass, relative to the total amount of the electroconductive layer. When it falls within the above range, it is possible to attain both desired developability and desired electroconductivity of metal nanowires.

### —Photosensitive Compound—

The photosensitive compound refers to a compound that provides the electroconductive layer with a function of forming an image upon exposure to light or that triggers for forming an image upon exposure to light. Specifically, it is, for example, (1) a compound that generates an acid upon exposure to light (i.e., a photoacid generator), (2) a photosensitive quinonediazide compound and (3) a photoradical generator. These may be used alone or in combination. In addition, a sensitizer or other agents may be used in combination for controlling sensitivity.

### —(1) Photoacid Generator—

The (1) photoacid generator used may be appropriately selected from photoinitiators for photocation polymerization, photoinitiators for photoradical polymerization, light color eraser and light color modifier for dyes, known compounds used in, for example, microresists which generate an acid upon irradiation of active light beams or radiation beams, and mixtures thereof.

The (1) photoacid generator is not particularly limited and may be appropriately selected depending on the intended purpose. Examples thereof include diazonium salts, phosphonium salts, sulfonium salts, iodonium salts, imidesulfonate, oximesulfonate, diazodisulfone, disulfone and o-nitrobenzyl sulfonate. Among them, particularly preferred are imidesulfonate, oximesulfonate and o-nitrobenzyl sulfonate which are compounds generating sulfonic acid.

In addition, compounds where a group or compound generating an acid upon irradiation of active light beams or radiation beams is introduced to a main or side chain of a resin may also be used. Such compounds are described in, for example, U.S. Pat. No. 3,849,137, Germany Patent No. 3914407, and JP-A No. 63-26653, 55-164824, 62-69263, 63-146038, 63-163452, 62-153853 and 63-146029.

Furthermore, compounds generating by the action of light described in, for example, U.S. Pat. No. 3,779,778 and European Patent No. 126,712 may also be used.

### —(2) Quinonediazide Compound—

The (2) quinonediazide compound is obtained by, for example, subjecting 1,2-quinonediazidesulfonylchlorides, hydroxyl compounds or amino compounds to condensation reaction in the present of a dehydrochloric acid.

The amount of the (1) photoacid generator or the (2) quinonediazide compound is preferably 1 part by mass to 100 parts by mass, more preferably 3 parts by mass to 80 parts by mass, per 100 parts by mass of the binder, from the viewpoints of the difference in dissolution rate between exposed regions and non-exposed regions and the allowable range of sensitivity.

Notably, the (1) photoacid generator and the (2) quinonediazide compound may be used in combination.

In the present invention, compounds generating sulfonic acid are preferred among the (1) photoacid generators. The following oximesulfonate compounds are particularly preferred from the viewpoint of high sensitivity.

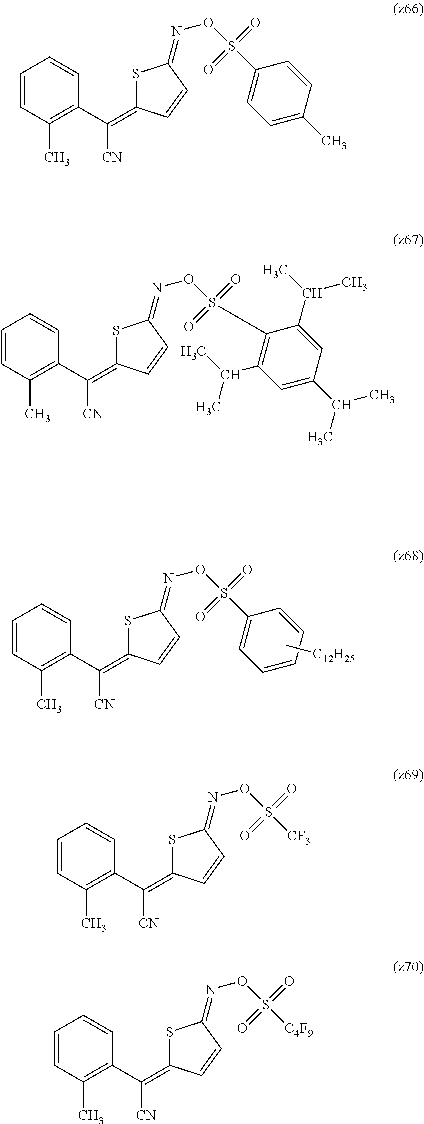

As the (2) quinonediazide compound, compounds containing a 1,2-naphthoquinonediazide group are highly sensitive and provide good developability.

The following compounds where Ds are independently a hydrogen atom or 1,2-naphthoquinonediazide group are preferred among the (2) quinonediazide compounds from the viewpoint of high sensitivity.

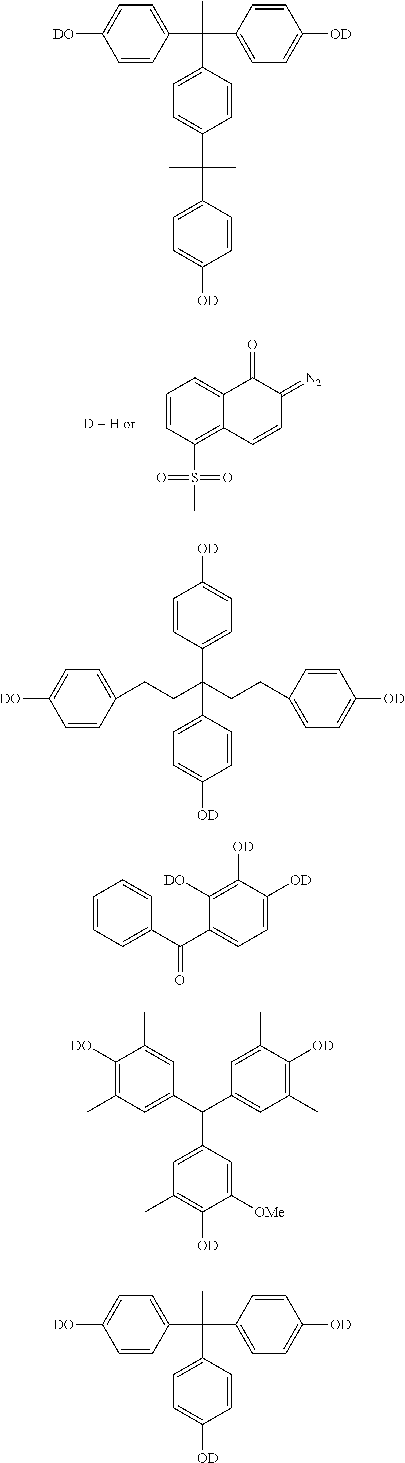

—(3) Photoradical Generator—

The photoradical generator has a function of generating polymerization-active radicals after it has directly absorbed light or it has been sensitized to cause decomposing reaction or hydrogen-abstracting reaction.

The photoradical generator is preferably a photoradical generator having absorption in a wavelength range of 300 nm to 500 nm.

The photoradical generators may be used alone or in combination. The amount of the photoradical generator is preferably 0.1% by mass to 50% by mass, more preferably 0.5% by mass to 30% by mass, further preferably 1% by mass to 20% by mass, relative to the total solid content of a coating liquid for the electroconductive layer. When it falls within the above numerical range, it is possible to obtain good sensitivity and pattern formability.

The photoradical generator is not particularly limited and may be appropriately selected depending on the intended purpose. Examples thereof include compounds described in JP-A No. 2008-268884. Among them, particularly preferred are triazine compounds, acetophenone compounds, acylphosphine(oxide) compounds, oxime compounds, imidazole compounds and benzophenone compounds, from the viewpoint of sensitivity to light exposure.

From the viewpoints of sensitivity to light exposure and transparency, the following compounds are suitable as the photoradical generator: 2-(dimethylamino)-2-[(4-methylphenyl)methyl]-1-[4-(4-morpholinyl)phenyl]-1-butan one, 2-benzyl-2-dimethylamino-1-(4-morpholinophenyl)-butanone-1,2-methyl-1-(4-methylthiophenyl)-2-morpholinopropan-1-one, 2,2′-bis(2-chlorophenyl)-4,4′,5,5′-tetraphenylbiimidazole, N,N-diethylaminobenzophenoene, 1,2-octandione and 1-[4-(phenylthio)-2-(o-benzolyloxime)].

The coating liquid for the electroconductive layer contains a chain transfer agent in combination with the photoradical generator in order to improve sensitivity to light exposure.

Examples of the chain transfer agent include: N,N-dialkylaminobenzoic acidalkyl esters such as N,N-dimethylaminobenzoic acid ethyl ester; mercapto compounds having a heterocyclic ring such as 2-mercaptobenzothiazole, 2-mercaptobenzoxazole, 2-mercaptobenzoimidazole, N-phenylmercaptobenzoimidazole, 1,3,5-tris(3-mercaptobutyloxyethyl)-1,3,5-triazine-2,4,6(1H,3H,5H)-trione; and aliphatic polyfunctional mercapto compounds such as pentaerythrithol tetrakis(3-mercaptopropionate), pentaerythrithol tetrakis(3-mercaptobutylate) and 1,4-bis(3-mercaptobutylyloxy)butane. These may be used alone or in combination.

The amount of the chain transfer agent is preferably 0.01% by mass to 15% by mass, more preferably 0.1% by mass to 10% by mass, further preferably 0.5% by mass to 5% by mass, relative to the total solid content of the coating liquid for the electroconductive layer.

### —Other Ingredients—

Examples of the other ingredients include various additives such as a crosslinking agent, a dispersing agent, a solvent, a surfactant, an antioxidant, a sulfurization inhibitor, a metal corrosion inhibitor, a viscosity adjuster and an antiseptic agent.

### —Crosslinking Agent—

The crosslinking agent is a compound that forms chemical bonds by free radicals or acids and heat to thereby cure the electroconductive layer. Examples thereof include melamine compounds containing, as a substituent, a methylol group, an alkoxymethyl group or an acyloxymethyl group or any combination thereof, guanamine compounds, glycoluril compounds, urea compounds, phenol compounds or ether compounds of phenols, epoxy compounds, oxetane compounds, thioepoxy compounds, isocyanate compounds and azide compounds; and compounds having an ethylenically unsaturated group such as a methacryloyl group or an acryloyl group. Among them, particularly preferred are epoxy compounds, oxetane compounds and compounds having an ethylenically unsaturated group, from the viewpoints of film properties, heat resistance and solvent resistance.

The oxetane resins may be used alone or in combination with the epoxy resins. In particular, use of the oxetane resins and the epoxy resins in combination is preferred since high reactivity is obtained to improve film properties.

The amount of the crosslinking agent is preferably 1 part by mass to 250 parts by mass, more preferably 3 parts by mass to 200 parts by mass, per 100 parts by mass of the binder.

### —Dispersing Agent—

The dispersing agent is used to prevent the metal nanowires from being aggregated to allow them to be dispersed. The dispersing agent is not particularly limited, so long as it can disperse the metal nanowires, and may be appropriately selected depending on the intended purpose. Examples thereof include commercially available low-molecular-weight pigment dispersing agents and polymeric pigment dispersing agents. Among them, preferred are polymeric dispersing agents having adsorbability onto the metal nanowires. Examples thereof include polyvinylpyrrolidone, BYK series (products of BYK Chemie), SOLSPERSE series (products of Nippon Lubrizol Corporation) and AJISPER series (product of Ajinomoto Co., Inc.).

The amount of the dispersing agent contained is preferably 0.1 parts by mass to 50 parts by mass, more preferably 0.5 parts by mass to 40 parts by mass, further preferably 1 part by mass to 30 parts by mass, per 100 parts by mass of the binder.

When the amount is less than 0.1 parts by mass, the metal nanowires may aggregate in a dispersing liquid. When the amount is more than 50 parts by mass, a stable liquid film may not be formed in a coating step, which may cause an uneven coating.

### —Solvent—

The solvent is not particularly limited and may be appropriately selected depending on the intended purpose. Examples thereof include propylene glycol monomethyl ether, propylene glycol monomethyl ether acetate, ethyl 3-ethoxypropionate, methyl 3-methoxypropionate, ethyl acetate, 3-methoxybutanol, water, 1-methoxy-2-propanol, isopropyl acetate, methyl lactate, N-methylpyrrolidone (NMP), γ-butyrolactone (GBL) and propylenecarbonate. These may be used alone or in combination.

### —Metal Corrosion Inhibitor—

The metal corrosion inhibitor is not particularly limited and may be appropriately selected depending on the intended purpose. Examples of the metal corrosion inhibitor suitably used include thiols and azoles.

Incorporation of the metal corrosion inhibitor provides more excellent corrosion inhibitory effects. The metal corrosion inhibitor may be dissolved in an appropriate solvent and then added to the coating liquid for the electroconductive layer in the form of a solution; or the metal corrosion inhibitor may be added to the coating liquid for the electroconductive layer in the form of powder. Alternatively, after the electroconductive layer has been formed from the coating liquid for the electroconductive layer, the formed electroconductive layer may be immersed in a bath of the metal corrosion inhibitor.

In the electroconductive layer, a mass ratio a/b is preferably 0.1 to 5, more preferably 0.5 to 3, where “a” is a mass of the other ingredient(s) than the metal nanowires in the electroconductive layer and “b” is a mass of the metal nanowires in the electroconductive layer. When the mass ratio a/b is less than 0.1, the metal nanowires may aggregate to degrade optical characteristics such as electroconductivity, transparency and haze. In addition, problems may arise such as degradation in the mechanical strength of the electroconductive layer and degradation in the adhesiveness to the base material, especially, degradation in quality of a pattern formed by patterning using photolithography (reproduction fidelity of the light-exposed pattern). When the mass ratio a/b is more than 5, the number of contact points between the metal nanowires decreases to potentially cause reduction of electroconductivity and degradation in optical characteristics such as transparency and haze.

The electroconductive layer is not particularly limited and may be appropriately selected depending on the intended purpose. The electroconductive layer may be formed by coating a composition for the electroconductive layer on the cushion layer.

The method for coating the composition for the electroconductive layer is not particularly limited and may be appropriately selected depending on the intended purpose. Examples thereof include a coating method, a printing method and an inkjet method.

Examples of the coating method include a roll coat method, a bar coat method, a dip coating method, a spin coating method, a casting method, a die coat method, a blade coat method, a gravure coat method, a curtain coat method, a spray coat method and a doctor coat method.

Examples of the printing method include a relief (letterpress) printing method, a stencil (screen) printing, a planographic (offset) printing method and an intaglio (gravure) printing method.

In the present invention, a change in resistance [{(Y−X)/X}×100] is preferably 0% to 50%, more preferably 0% to 20% where X is a resistance of the electroconductive layer before drawing of the electroconductive layer and Y is a resistance of the electroconductive layer after tensile drawing of the electroconductive layer in a horizontal direction at a draw ratio of 2%. When the change in resistance at a draw ratio of 2% is more than 50%, sufficient effects cannot be obtained and when a flexible support is used, electroconductivity may be lost.

Also, a change in resistance [{(Z−X)/X}×100] is preferably 0% to 100%, more preferably 0% to 50% where X is a resistance of the electroconductive layer before drawing of the electroconductive layer and Z is a resistance of the electroconductive layer after tensile drawing of the electroconductive layer in a horizontal direction at a draw ratio of 5%. When the change in resistance at a draw ratio of 5% is more than 100%, followability to concave and convex portions 2.5 μm or more in height may be degraded.

Here, the change in resistance [{(Y−X)/X}×100] after tensile drawing of the electroconductive layer in a horizontal direction at a draw ratio of 2% and the change in resistance [{(Z−X)/X}×100] after tensile drawing of the electroconductive layer in a horizontal direction at a draw ratio of 5% can be measured with, for example, DIGITAL TESTER CDM-2000D (product of CUSTOM Co.).

Furthermore, the electroconductive layer preferably has a melt viscosity at 110° C. of 500 Pa·s to 2,000,000 Pa·s, more preferably 1,000 Pa·s to 1,000,000 Pa·s, further preferably 10,000 Pa·s to 100,000 Pa·s. When the melt viscosity at 110° C. is less than 500 Pa·s, disconnection occurs easily. Whereas when it is more than 2,000,000 Pa·s, followability to concave/convex portions may be degraded.

Here, the melt viscosity at 110° C. can be measured by, for example, the method described in paragraph [0018] of JP-A No. 2008-107779.

That is, the melt viscosity of the electroconductive layer can be measured by the following method.

Specifically, a coating liquid for forming an electroconductive layer is coated on a glass plate, followed by drying for about 2 min in an oven set to 100° C., to thereby form a dry film having a thickness of about 15 μm. The formed film is further dried in vacuum at about 40° C. for about 6 hours. The degree of vacuum during drying in vacuum is 30 mmHg. After drying in vacuum, the film is peeled off from the glass plate and used as a sample. When the film cannot be peeled off easily and successfully, it is scraped off and collected, and used as a sample.

When the coating liquid for forming an electroconductive layer is not available, the electroconductive layer is peeled off from an electroconductive layer-transferring material and used as a measurement sample.

The above melt viscosity can be measured using, for example, a viscoelasticity measurement device DYNALYSER DAS-100 (product of Jasco International Co. Ltd) at a measurement temperature of 110° C. and a frequency of 1 Hz.

### <<Adhesive Layer>>

The shape, structure and size of the adhesive layer are not particularly limited and may be appropriately selected depending on the intended purpose.

Examples of the shape include a film and a sheet. Examples of the structure include a monolayer structure and a laminated structure. The size may be appropriately selected depending on the intended application.

The adhesive layer is provided on the electroconductive layer and contains at least a polymer; and, if necessary, further contains other ingredients.

### —Polymer—

The polymer is not particularly limited and may be appropriately selected depending on the intended purpose. Examples thereof include acryl resins, styrene-acryl copolymers, polyvinyl alcohols, polyethylenes, ethylene-vinyl acetate copolymers, ethylene-ethyl acrylate copolymers, ethylene-methacrylic acid copolymers, polyvinyl chloride gelatine; cellulose esters such as cellulose nitrate, cellulose acetate, cellulose diacetate, cellulose acetate butyrate and cellulose acetate propionate; homopolymers or copolymers containing vinylidene chloride, vinyl chloride, styrene, acrylonitrile, vinyl acetate, alkyl (C1 to C4) acrylates and/or vinyl pyrrolidone; soluble polyesters, polycarbonates and soluble polyamides. These may be used alone or in combination.

Examples of the other ingredients include plasticizers, supercooling compounds, adhesiveness improving agents, surfactants, releasing agents, thermal polymerization inhibitors and solvents.

The adhesive layer can be formed by coating the electroconductive layer with an adhesive layer-coating liquid containing the polymer and the other ingredients used if necessary, followed by drying.

The method for the coating is not particularly limited and may be appropriately selected depending on the intended purpose. Examples thereof include a roll coat method, a bar coat method, a dip coating method, a spin coating method, a casting method, a die coat method, a blade coat method, a gravure coat method, a curtain coat method, a spray coat method and a doctor coat method.

The average thickness of the adhesive layer is not particularly limited and may be appropriately selected depending on the intended purpose, but is preferably 0.1 μm to 5 μm, more preferably 0.2 μm to 3 μm.

### —Other Layers—

In the present invention, when the electroconductive layer does not contain any photosensitive materials (e.g., a binder and a photosensitive compound), a photosensitive layer is preferably provided between the base material or the cushion layer and the electroconductive layer, between the electroconductive layer and the adhesive layer, or between the electroconductive layer and the transfer target.

The photosensitive layer contains at least a binder; and, if necessary, further contains a photosensitive compound and other ingredients.

The binder and the photosensitive compound are is not particularly limited and may be appropriately selected depending on the intended purpose. They may be binders and photosensitive compounds similar to those used for the electroconductive layer.

The thickness of the photosensitive layer is not particularly limited and may be appropriately selected depending on the intended purpose, but is preferably 0.01 μm to 100 μm, more preferably 0.05 μm to 10 μm.

The uppermost surface of the electroconductive layer-transferring material of the present invention is preferably covered with a protective film.

The protective film is to be peeled off when the electroconductive layer-transferring material is transferred to the transfer target.

The protective film is not particularly limited and may be appropriately selected depending on the intended purpose. Examples thereof include a polypropylene film, a polyethylene film, silicone paper, polyethylene- or polypropylene-laminated paper, a polyolefin sheet and a polytetrafluoroethylene sheet. Among them, a polyethylene film and a polypropylene film are particularly preferred.

### <Patterning Treatment>

The patterning treatment is a treatment of light-exposing and developing the electroconductive layer in the electroconductive layer-transferring material of the present invention or the electroconductive layer transferred onto the transfer target from the electroconductive layer-transferring material of the present invention.

The patterning treatment contains a light-exposing step and a developing step; and,

if necessary, further includes other steps.

### —Light-Exposing Step—

The light-exposing step is a step of light-exposing the electroconductive layer in the electroconductive layer-transferring material of the present invention or the electroconductive layer transferred onto the transfer target from the electroconductive layer-transferring material of the present invention.

The light-exposing may be performed by light exposure using a photomask or performed by scanning laser beams. The method for the light-exposing may be refraction-type light exposure using a lens or reflection-type light exposure using a reflection mirror. Specifically, it may be, for example, contact light exposure, proximity light exposure, reduction projection light exposure and reflection projection light exposure.

### —Developing Step—

The developing step is a step of applying a solvent to develop light-exposed regions or non-light-exposed regions or both the regions in the electroconductive layer.

When the photosensitive layer is provided, the developing step removes light-exposed regions or non-light-exposed regions in the photosensitive layer.

The solvent is not particularly limited and may be appropriately selected depending on the intended purpose, but is preferably an alkaline solution.

The alkali contained in the alkaline solution is not particularly limited and may be appropriately selected depending on the intended purpose. Examples thereof include tetramethylammoniumhydroxide, tetraethylammoniumhydroxide, 2-hydroxyethyltrimethylammoniumhydroxide, sodium carbonate, sodium hydrogen carbonate, potassium carbonate, potassium hydrogen carbonate, sodium hydroxide and potassium hydroxide.

The method for applying the alkaline solution is not particularly limited and may be appropriately selected depending on the intended purpose. Examples thereof include coating, immersing and spraying.

Specific examples thereof include a method where the electroconductive layer-transferring material of the present invention is immersed in the alkaline solution, a method where the alkaline solution is applied to the electroconductive layer-transferring material of the present invention using a shower or spray, and a method where the alkaline solution is applied to the electroconductive layer-transferring material of the present invention using a napkin soaked with the alkaline solution. Among them, particularly preferred is a method where the electroconductive layer-transferring material of the present invention is immersed in the alkaline solution

The time for which it is immersed in the alkaline solution is not particularly limited and may be appropriately selected depending on the intended purpose, but is preferably 10 sec to 5 min.

The patterning treatment may be performed by patternwise coating the electroconductive layer with a dissolution liquid which dissolves the electroconductive fibers, so that the coated parts become non-electroconductive parts. The dissolution liquid which dissolves the electroconductive fibers is not particularly limited and may be appropriately selected depending on the intended purpose so long as it can dissolve the electroconductive fibers to thereby form non-electroconductive parts. In the case that the electroconductive fibers are silver nanowires, examples thereof include a bleaching-fixing liquid mainly used in a bleaching-fixing step of printing papers made from silver halide color photosensitive material in a so-called photoscience industry, strong acids such as dilute nitric acid, an oxidizing agent, and hydrogen peroxide. Among them, preferred are a bleaching-fixing liquid, a dilute nitric acid solution, and hydrogen peroxide water, and particularly preferred is a bleaching-fixing liquid. Notably, the silver nanowires may not be completely dissolved or cut with the dissolution liquid in the dissolution liquid-coated region so long as electroconductivity is eliminated.

### <Transfer Method>

Next will be described a method for transferring the electroconductive layer using the electroconductive layer-transferring material of the present invention.

First, the cushion layer and the electroconductive layer of the electroconductive layer-transferring material of the present invention are laminated on the transfer target under pressing and heating. The lamination of these layers can be performed using a conventionally known laminator or a vacuum laminator. An autocut laminator can also be used in order to enhance productivity. Thereafter, the base material is peeled off, so that the cushion layer and the electroconductive layer are transferred to the transfer target.

The transfer target is not particularly limited and may be appropriately selected depending on the intended purpose. Examples thereof include a substrate and a liquid crystal cell. Among them, particularly preferred are a transparent glass substrate and a liquid crystal cell.

The shape, structure and size of the substrate are not particularly limited and may be appropriately selected depending on the intended purpose. Examples of the shape include a film and a sheet. Examples of the structure include a monolayer structure and a laminated structure. The size may be appropriately selected depending on the intended application.

The substrate is not particularly limited and may be appropriately selected depending on the intended purpose. Examples thereof include transparent glass substrates, synthetic resin sheets (films), metal substrates, ceramic plates and semiconductor substrates having photoelectric conversion elements. These substrates may be pre-treated, as desired, through, for example, a chemical treatment using a silane coupling agent, a plasma treatment, ion plating, sputtering, a vapor phase reaction method, and vacuum vapor deposition.

Examples of the transparent glass substrates include white plate glasses, blue plate glasses and silica-coated blue glasses.

Examples of the synthetic resin sheets include those made of, for example, polyethylene terephthalate (PET) sheets, polycarbonate sheets, polyethersulfone sheets, polyester sheets, acrylic resin sheets, vinyl chloride resin sheets, aromatic polyamide resin sheets, polyamideimide sheets and polyimide sheets.

Examples of the metal substrates include aluminum plates, copper plates, nickel plates and stainless steel plates.

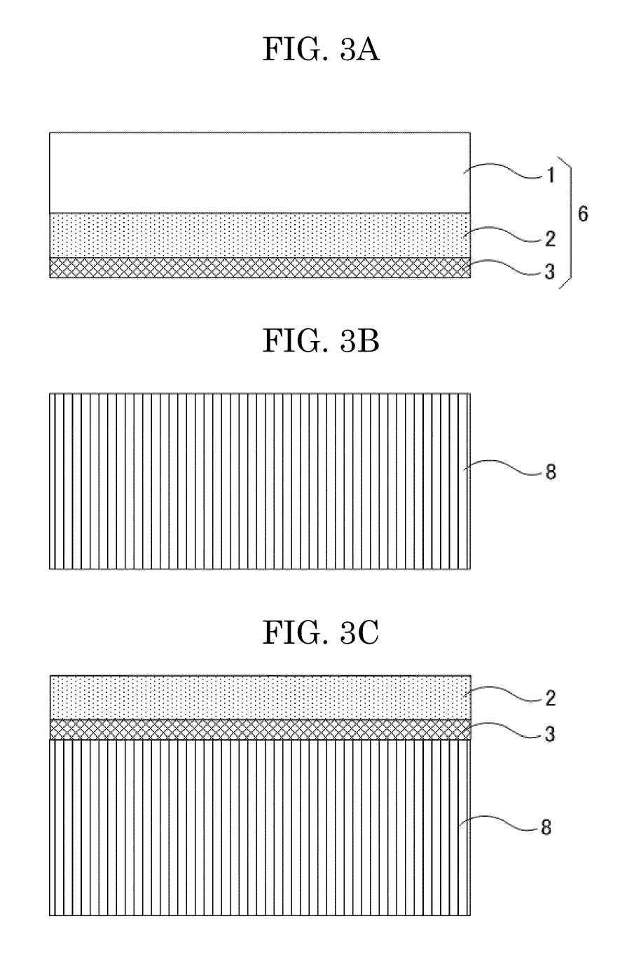

Here, FIGS. 3A to 3C illustrate a transfer method using an electroconductive layer-transferring material 6 of the present invention.

The electroconductive layer-transferring material 6 illustrated in FIG. 3A contains a base material 1 and a cushion layer 2 and an electroconductive layer 3 which are on one surface of the base material in this order, and the cushion layer 2 and the electroconductive layer 3 are laminated with pressing and heating onto a glass substrate 8 serving as the transfer target using a laminator (see FIG. 3B). Subsequently, the base material 1 is peeled off, so that the cushion layer 2 and the electroconductive layer 3 are transferred to the glass substrate 8 (see FIG. 3C).

Some of the transfer targets have a uniform surface and others have a concave/convex surface. Especially when transfer targets having a concave/convex surface are used, followability of the electroconductive layer to the transfer targets may be poor. In this case, there may be a change in resistance or the transfer speed has to be low. When the electroconductive layer-transferring material of the present invention is used to transfer the electroconductive layer to the transfer target having a concave/convex surface, it is possible to enhance productivity since the electroconductive layer-transferring material is excellent in followability to cause a change in resistance hardly and increase the transfer speed.

The transfer speed of the electroconductive layer of the electroconductive layer-transferring material is preferably 0.1 cm/sec or more, more preferably 0.5 cm/sec or more, particularly preferably 0.5 cm/sec to 10 cm/sec. The concave/convex surface is a surface having height differences periodically appearing. The electroconductive layer-transferring material of the present invention exhibits satisfactory followability to height differences 0.8 μm or more in height. The electroconductive layer-transferring material of the present invention can achieve transfer even on a surface having a height difference 1 μm or height with a change in resistance low. It can respond to a height difference 1 μm to 10 μm in height, more preferably 1 μm to 5 μm in height.

The electroconductive layer of the electroconductive layer-transferring material of the present invention preferably has a surface resistance of 0.1 Ω/sq. to 5,000 Ω/sq., more preferably 0.1 Ω/sq. to 1,000 Ω/sq. Lower surface resistances do not involve unfavorable effects basically. However, when the surface resistance is less than 0.1 Ω/sq., it may be difficult to obtain an electroconductor having a high light transmittance. When it is more than 5,000 Ω/sq., disconnection occurs more easily due to Joule heat generated during application of a current. In addition, voltage drop occurs upstream and downstream of the wiring to cause problems such as limitation of the area usable for a touch panel.

Here, the surface resistance can be measured with, for example, a surface resistance meter (LORESTA-GP MCP-T600; product of Mitsubishi Chemical Corporation).

The electroconductive layer of the electroconductive layer-transferring material of the present invention preferably has a total visible light transmittance of 85% or more, more preferably 90% or more. When the total visible light transmittance is less than 85%, an electroconduction pattern becomes noticeable when it is used for image display media such as a touch panel, leading to a drop in image qualities. In addition, there may be disadvantages such as increase in electric power consumed for compensating reduction of brightness.

Here, the total visible light transmittance can be measured using, for example, a magnetic spectrophotometer (UV2400-PC, product of Shimadzu Corporation).

The electroconductive layer transferred to the transfer target from the electroconductive layer-transferring material of the present invention has high transmittance, low resistance, and improved durability and flexibility, and can be easily patterned, and thus, can be widely used for a touch panel, a display electrode, an electromagnetic shield, an organic EL display electrode, an inorganic EL display electrode, electronic paper, a flexible display electrode, an integrated solar battery, a liquid display device, a display crystal device having a function of a touch panel, and other various devices. Among them, particularly preferred are a touch panel and a liquid display device.

### (Liquid Display Device)

A liquid crystal display device of the present invention is not particularly limited and may be appropriately selected depending on the intended purpose so long as it includes a glass substrate or a liquid crystal cell containing the electroconductive layer transferred from the electroconductive layer-transferring material of the present invention.

The liquid crystal display device includes a color filter and a backlight; and, if necessary, further includes other members.

Liquid crystal display devices are described in, for example, “Next-Generation Liquid Crystal Display Technology (edited by Tatsuo Uchida, published by Kogyo Chosakai Publishing Inc., 1994).” Liquid crystal displays to which the present invention can be applied are not particularly limited, and the present invention can be applied to, for example, various liquid crystal displays described in the above “Next-Generation Liquid Crystal Display Technology.”

Liquid crystals used in the above liquid crystal display devices; i.e., liquid crystal compounds and liquid crystal compositions are not particularly limited and may be any liquid crystal compounds and any liquid crystal compositions.

In addition to the electrode substrate and the liquid crystal layer, the liquid crystal cell may contain various components required for forming the below-listed various liquid crystal cells.

Examples of modes of the liquid crystal cells include TN (Twisted Nematic) mode, STN (SuperTwisted Nematic) mode, ECB (Electrically Controlled Birefringence) mode, IPS (In-Plane Switching) mode, VA (Vertical Alignment) mode, MVA (Multidomain Vertical Alignment) mode, PVA (Patterned Vertical Alignment) mode, OCB (Optically Compensated Birefringence) mode, HAN (Hybrid Aligned Nematic) mode, ASM (Axially Symmetric Aligned Microcell) mode, halftone gray scale mode, domain partition mode, and various display modes utilizing ferroelectric liquid crystals or anti-ferroelectric liquid crystals.

Drive mode of the liquid crystal cells is not particularly limited and may be appropriately selected depending on the intended purpose. The drive mode may be passive matrix mode used in, for example, STN-LCD; or may be active matrix mode or plasma address mode using a positive electrode such as a TFT (Thin Film Transistor) electrode and a TFD (Thin Film Diode) electrode. Also, the drive mode may be field sequential mode without using a color filter.

### (Touch Panel)

The touch panel of the present invention is not particularly limited and may be appropriately selected depending on the intended purpose, so long as it contains the electroconductive layer transferred from the electroconductive layer-transferring material of the present invention. Examples of the touch panel include a surface capacitive touch panel, a project capacitive touch panel and a resistive touch panel. Notably, the touch panel encompasses so-called touch sensors and touch pads.

The electrode parts of the touch panel sensor in the touch panel preferably has any of the following layer constructions: a bonding type in which two transparent electrodes are bonded together, a type in which transparent electrodes are provided on both sides of one substrate, a one-side jumper type, a through-hole type, or a one-side lamination type.

Here, one example of the surface capacitive touch panel will be described with reference to FIG. 4. In FIG. 4, a touch panel 10 includes a transparent substrate 11, a transparent electroconductor 12 (corresponding to the electroconductive layer transferred from the electroconductive layer-transferring material of the present invention) disposed so as to uniformly cover the surface of the transparent substrate 11, and an electrode terminal 18 for electrical connection with an external detection circuit (not shown), where the electrode terminal 18 is formed on the transparent electroconductor 12 at the end of the transparent substrate 11.

Notably, in FIG. 4, reference numeral 13 denotes a transparent electroconductor serving as a shield electrode, reference numeral 14 or 17 denotes a protective film, reference numeral 15 denotes an intermediate protective film, and reference numeral 16 denotes an antiglare layer.

For example, when touching any point on the transparent electroconductor 12 with a finger, the transparent electroconductor 12 is connected at the touched point to ground via the human body, which causes a change in resistance between the electrode terminal 18 and the grounding line. The change in resistance therebetween is detected by the external detection circuit, whereby the coordinate of the touched point is identified.

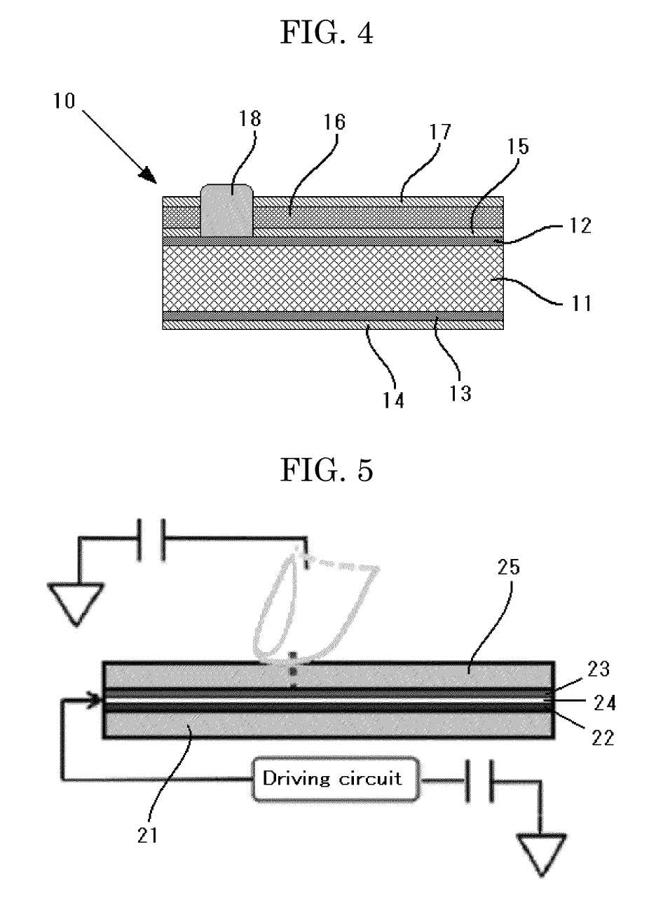

Another example of the surface capacitive touch panel will be described with reference to FIG. 5. In FIG. 5, a touch panel 20 includes a transparent substrate 21, a transparent electroconductor 22 (corresponding to the electroconductive layer transferred from the electroconductive layer-transferring material of the present invention), a transparent electroconductor 23, an insulating layer 24 and an insulating cover layer 25, where the transparent electroconductor 22 and the transparent electroconductor 23 are disposed so as to cover the surface of the transparent substrate 21. The insulating layer 24 insulates the transparent electroconductor 22 from the transparent electroconductor 23. The insulating cover layer 25 creates capacitance between the transparent electroconductor 22 or 23 and a contact object such as a finger coming into contact with the touch panel. In this touch panel, the position of the contact object such as the finger coming into contact with the touch panel is detected. Depending on the intended configuration, the transparent electroconductors 22 and 23 may be formed as a single member and also, the insulating layer 24 or the insulating cover layer 25 may be formed as an air layer.

When touching the insulating cover layer 25 with contact object such as the finger, a change in capacitance is caused between the contact object such as the finger and the transparent electroconductor 22 or the transparent electroconductor 23. The change in capacitance therebetween is detected by the external detection circuit, whereby the coordinate of the touched point is identified.

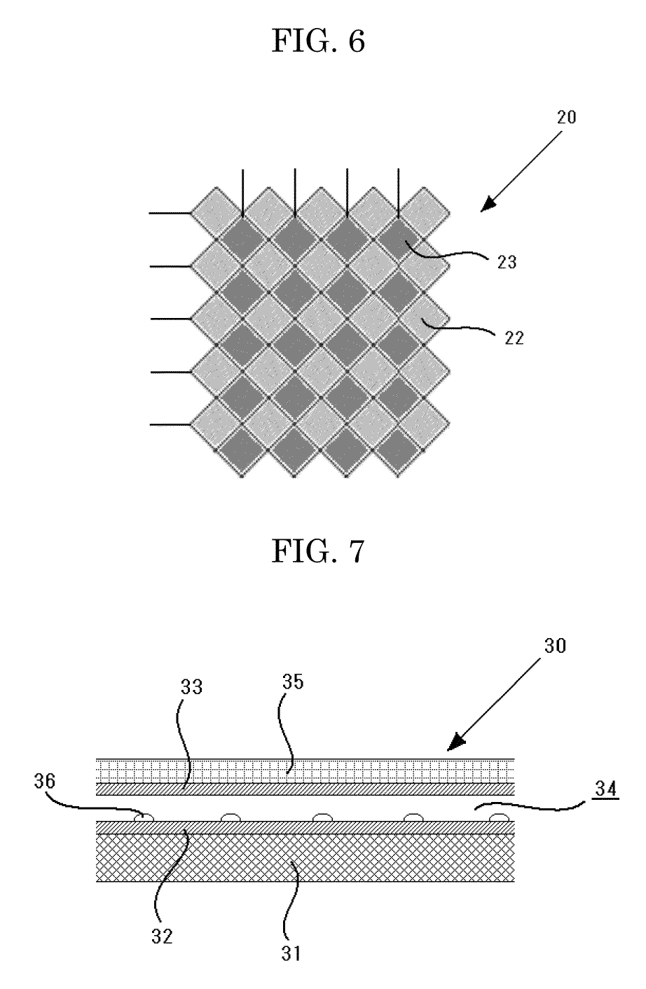

Also, a touch panel 20 as a project capacitive touch panel will be schematically described with reference to FIG. 6 which is a plan view of the arrangement of transparent electroconductors 22 and transparent electroconductors 23.

The touch panel 20 includes a plurality of the transparent electroconductors 22 capable of detecting the position in the X axis direction and a plurality of the transparent electroconductors 23 arranged in the Y axis direction, where these transparent electroconductors 22 and 23 are disposed so that they can be connected with external terminals. A plurality of the transparent electroconductors 22 and 23 come into contact with the contact object such as the finger, whereby contact information can be input at a plurality of points.

For example, when touching any point on the touch panel 20 with a finger, the coordinates in the X axis direction and the Y axis direction are indentified with high positional accuracy.

Notably, the other members such as a transparent substrate and a protective layer may be appropriately selected from the members of the surface capacitive touch panel. Also, the above-described pattern of the transparent electroconductors containing the transparent electroconductors 22 and 23 in the touch panel 20 is non-limiting example, and thus, for example, the shape and arrangement are not limited thereto.

One example of the resistive touch panel will be described with reference to FIG. 7. In FIG. 7, a touch panel 30 includes a transparent electroconductor 32 (corresponding to the electroconductive layer transferred from the electroconductive layer-transferring material of the present invention), a substrate 31, a plurality of spacers 36, an air layer 34, a transparent electroconductor 33 and a transparent film 35, where the transparent electroconductor 32 is disposed on the substrate 31, the spacers 36 are disposed on the transparent electroconductor 32, the transparent electroconductor 33 can come into contact via the air layer 34 with the transparent electroconductor 32, and the transparent film 35 is disposed on the transparent electroconductor 33. These members are supported in this touch panel.

When touching the touch panel 30 from the side of the transparent film 35, the transparent film 35 is pressed and the pressed transparent electroconductor 32 and the pressed transparent electroconductor 33 come into contact with each other. A change in voltage at this point is detected with an external detection circuit (not shown), whereby the coordinate of the touched point is indentified.

The above touch panel may be combined with a display device. The display device is preferably a liquid crystal device. The liquid crystal device is similar to those of the present invention.

The liquid crystal display device and the touch panel of the present invention each contain an electroconductive layer excellent in electroconductivity and transparency. These have a less number of parts and can be light and thin as well as have excellent display characteristics such as wide viewing angles, high contrast and high image qualities.

### EXAMPLES

The present invention will next be described by way of Examples, which should not be construed as limiting the present invention thereto.

In the following Examples, the average thicknesses of a base material, an electroconductive layer and a cushion layer were measured in the below-described manner.

### <Measurement of the Average Thicknesses of the Base Material, the Electroconductive Layer and the Cushion Layer>

An electroconductive layer-transferring material is cut with a microtome to expose the cross-sections of the base material, the electroconductive layer and the cushion layer, and the exposed cross-sections are observed under an SEM. Alternatively, an electroconductive layer-transferring material is wrapped with an epoxy resin and then cut with a microtome to prepare its cut section, and the cut section is observed under a TEM. The average thickness of each of the base material, the electroconductive layer and the cushion layer is an average of 10 values measured at 10 points therein.

### Synthesis Example 1

### Synthesis of Binder (A-1)

Methacrylic acid (MAA) (7.79 g) and benzyl methacrylate (BzMA) (37.21 g) (serving as monomer components constituting a copolymer) were polymerized in propylene glycol monomethyl ether acetate (PGMEA) (55.00 g) (serving as a solvent) in the presence of azobisisobutyronitrile (AIBN) (0.5 g) (serving as a radical polymerization initiator) to thereby obtain a solution of Binder (A-1) in PGMEA (solid content concentration=45% by mass). Binder (A-1) is represented by the following formula. Notably, the polymerization temperature was adjusted to 60° C. to 100° C.

The weight average molecular weight (Mw) of Binder (A-1) was measured with a gel permeation chromatography (GPC) method, and was found to have a weight average molecular weight (Mw) converted to polystyrene of 30,000, and the molecular weight distribution (Mw/Mn) of 2.21.

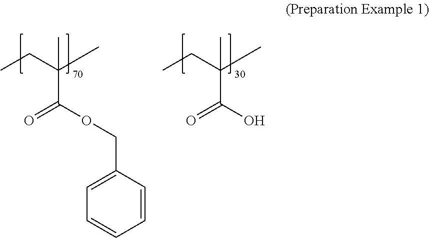

### —Preparation of Silver Nanowire Aqueous Dispersion Liquid—

The following additive liquids A, G and H were prepared in advance.

### [Additive Liquid A]

Silver nitrate powder (0.51 g) was dissolved in pure water (50 mL). Subsequently, 1N aqueous ammonia was added to the resultant solution until the solution became transparent. Then, pure water was added to the transparent solution so that the total amount was 100 mL.

### [Additive Liquid G]

Glucose powder (0.5 g) was dissolved in pure water (140 mL) to thereby prepare additive liquid G.

### [Additive Liquid H]

Hexadecyl-trimethylammonium bromide (HTAB) powder (0.5 g) was dissolved in pure water (27.5 mL) to thereby prepare additive liquid H.

Next, a silver nanowire aqueous dispersion liquid was prepared in the following manner.

Specifically, pure water (410 mL) was added to a three-necked flask. With stirring at 20° C., the additive liquid H (82.5 mL) and the additive liquid G (206 mL) were added to the flask using a funnel (first step). The additive liquid A (206 mL) was added to the resultant liquid at a flow rate of 2.0 mL/min under stirring at 800 rpm (second step). Ten minutes after, the additive liquid H (82.5 mL) was added thereto (third step). The resultant mixture was increased to an internal temperature of 75° C. at a temperature increasing rate of 3° C./min, followed by heating for 5 hours under stirring at 200 rpm.

The obtained aqueous dispersion liquid was cooled. Separately, an ultrafiltration apparatus was assembled by connecting together, via silicone tubes, an ultrafiltration module SIP1013 (product of Asahi Kasei Corporation, molecular weight cut-off: 6,000), a magnet pump and a stainless steel cup.

The obtained aqueous dispersion liquid (aqueous solution) was added to the stainless steel cup and ultrafiltrated by operating the pump. At the time when the amount of the filtrate supplied from the module reached 50 mL, distilled water (950 mL) was added to the stainless steel cup for washing. The washing was repeated until the conductivity reached 50 μS/cm or lower, followed by concentrating, to thereby obtain a silver nanowire aqueous dispersion liquid of Preparation Example 1.

The silver nanowires in the obtained silver nanowire aqueous dispersion liquid of Preparation Example 1 were measured as follows in terms of average minor axis length, average major axis length, ratio of silver nanowires having an aspect ratio of 10 or more, and variation coefficient of minor axis lengths of silver nanowires. The results are presented in Table 1.

### <Average Minor Axis Length (Average Diameter) and Average Major Axis Length of Silver Nanowires>

Three hundred silver nanowires were observed under a transmission electron microscope (TEM) (JEM-2000FX, product of JEOL Ltd.) to determine the average minor axis length and the average major axis length of the silver nanowires

### <Variation Coefficient of Minor Axis Lengths of Silver Nanowires>

The minor axis lengths of 300 silver nanowires were measured through observation under a transmission electron microscope (TEM) (JEM-2000FX, product of JEOL Ltd.). Then, the variation coefficient was obtained by calculating the standard deviation and the average of the minor axis lengths measured. Separately, the amount of silver having passed through a filter paper was measured to determine a ratio of the silver nanowires each having a minor axis length of 50 nm or less and a major axis length of 5 μm or more as the ratio (%) of the silver nanowires having an aspect ratio of 10 or more.

Note that, a membrane filter (FALP 02500, product of Millipore K.K., pore size: 1.0 μm) was used for separating the silver nanowires when the above ratio was determined.

### Preparation Example 2

A silver nanowire aqueous dispersion liquid of Preparation Example 2 was prepared in the same manner as in Preparation Example 1 except that the half amount of the HTAB was replaced with OTAB (octadecyl-trimethylammonium bromide) and the heating time in the third step was shortened from 5 hours to 3.5 hours.

The silver nanowires in the obtained silver nanowire aqueous dispersion liquid of Preparation Example 2 were measured in the same manner as in Preparation Example 1 in terms of average minor axis length, average major axis length, ratio of silver nanowires having an aspect ratio of 10 or more, and variation coefficient of minor axis lengths of silver nanowires. The results are presented in Table 1.

TABLE 1

| | Average | Average | | Ratio of silver nano- |
|---|---|---|---|---|
| | minor axis | major axis | Variation | wires having an aspect |
| | length | length | coefficient | ratio of 10 or more |
| | (nm) | (μm) | (%) | (%) |
| Silver nano- | 17.5 | 36.8 | 18.3 | 83.2 |
| wires of | | | | |
| Preparation | | | | |
| Example 1 | | | | |
| Silver nano- | 20.5 | 15 | 19.1 | 85.3 |
| wires of | | | | |
| Preparation | | | | |
| Example 2 | | | | |

### Example 1

### Electroconductive Layer-Transferring Material of Sample No. 101

### <<Formation of Cushion Layer>>

A coating liquid for a cushion layer having the following formulation was coated on a base material which is a polyethylene terephthalate (PET) film having an average thickness of 30 μm, followed by drying, to thereby form a cushion layer having an average thickness of 10 μm.

### —Formulation of Coating Liquid for Cushion Layer—

Methyl methacrylate/2-ethylhexyl acrylate/benzyl methacrylate/methacrylic acid copolymer (copolymerization compositional ratio (molar ratio)=55/30/10/5, weight average molecular weight=100,000, glass transition temperature (Tg)=70° C.): 6.0 parts by mass
Styrene/acrylic acid copolymer (copolymerization compositional ratio (molar ratio)=65/35, weight average molecular weight=10,000, glass transition temperature (Tg)=100° C.): 14.0 parts by mass
BPE-500 (product of Shin-Nakamura Chemical Co., Ltd.): 9.0 parts by mass
MEGAFACE F-780-F (product of DIC Corporation): 0.5 parts by mass
Methanol: 10.0 parts by mass
Propylene glycol monomethyl ether acetate: 5.0 parts by mass
Methyl ethyl ketone: 55.5 parts by mass

### <<Formation of Electroconductive Layer>>

### —Preparation of MFG Dispersion Liquid of Silver Nanowires (Ag-1)—

Polyvinyl pyrrolidone (K-30, product of Wako Pure Chemical Industries, Ltd.) and 1-methoxy-2-propanol (MFG) were added to the silver nanowire aqueous dispersion liquid of Preparation Example 1, followed by centrifugation. The supernatant (water) was removed through decantation and then MEG was added to the precipitate for redispersion. This centrifugation/decantation/redispersion procedure was repeated three times in total to thereby obtain a silver nanowire MFG dispersion liquid (Ag-1). The amount of MFG added at the last time was adjusted so that the amount of silver became 1% by mass.

### —Preparation of Composition for Negative-type Electroconductive Layer—

The following were mixed together and stirred to prepare a composition for a negative-type electroconductive layer.

Binder (A-1) of Synthesis Example 1: 0.241 parts by mass

KAYARAD DPHA (product of NIPPON KAYAKU Co., Ltd.): 0.252 parts by mass

IRGACURE379 (product of Ciba Specialty Chemicals Co., Ltd.): 0.0252 parts by mass

EHPE-3150 (product of Daicel Corporation, Ltd.) serving as a crosslinking agent: 0.0237 parts by mass

MEGAFACE F781F (DIC Corporation): 0.0003 parts by mass

Propylene glycol monomethyl ether acetate (PGMEA): 0.9611 parts by mass

1-Methoxy-2-propanol (MFG): 44.3 parts by mass

Silver nanowire MFG dispersion liquid (Ag-1): 54.1 parts by mass

### —Formation of Electroconductive Layer—

The obtained composition for a negative-type electroconductive layer was coated on the film, on which the cushion layer had been formed, so that the amount of silver coated became 0.05 g/m², followed by drying, to thereby form an electroconductive layer having an average thickness of 0.1 μm. Through the above procedure, an electroconductive layer-transferring material of Sample No. 101 was produced.

Here, a mass ratio of A/B was found to be 0.6, where A is a mass of the other ingredients in the electroconductive layer than the metal nanowires and B is a mass of the metal nanowires in the electroconductive layer.

### <Electroconductive Layer-Transferring Material of Sample No. 102>

An electroconductive layer-transferring material of Sample No. 102 was produced in the same manner as in the production of Sample No. 101 except that the cushion layer was formed so as to have an average thickness of 5 μm.

### <Electroconductive Layer-Transferring Material of Sample No. 103>

An electroconductive layer-transferring material of Sample No. 103 was produced in the same manner as in the production of Sample No. 101 except that the cushion layer was formed so as to have an average thickness of 20 μm.

### <Electroconductive Layer-Transferring Material of Sample No. 104>

An electroconductive layer-transferring material of Sample No. 104 was produced in the same manner as in the production of Sample No. 101 except that the electroconductive layer was formed so as to have an average thickness of 0.01 μm.

### <Electroconductive Layer-Transferring Material of Sample No. 105>

An electroconductive layer-transferring material of Sample No. 105 was produced in the same manner as in the production of Sample No. 101 except that the electroconductive layer was formed so as to have an average thickness of 0.05 μm.

### <Electroconductive Layer-Transferring Material of Sample No. 106>

An electroconductive layer-transferring material of Sample No. 106 was produced in the same manner as in the production of Sample No. 101 except that the electroconductive layer was formed so as to have an average thickness of 0.15 μm.

### <Electroconductive Layer-Transferring Material of Sample No. 107>

An electroconductive layer-transferring material of Sample No. 107 was produced in the same manner as in the production of Sample No. 101 except that the electroconductive layer was formed so as to have an average thickness of 0.2 μm.

### <Electroconductive Layer-Transferring Material of Sample No. 108>

An electroconductive layer-transferring material of Sample No. 108 was produced in the same manner as in the production of Sample No. 101 except that the cushion layer was formed so as to have an average thickness of 1 μm.

### <Electroconductive Layer-Transferring Material of Sample No. 109>

An electroconductive layer-transferring material of Sample No. 109 was produced in the same manner as in the production of Sample No. 101 except that the cushion layer was formed so as to have an average thickness of 25 μm.

### <Electroconductive Layer-Transferring Material of Sample No. 110>

An electroconductive layer-transferring material of Sample No. 110 was produced in the same manner as in the production of Sample No. 101 except that the cushion layer was formed so as to have an average thickness of 50 μm.

### <Electroconductive Layer-Transferring Material of Sample No. 111>

An electroconductive layer-transferring material of Sample No. 111 was produced in the same manner as in the production of Sample No. 101 except that the electroconductive layer was formed so as to have an average thickness of 0.5 μm.

### <Electroconductive Layer-Transferring Material of Sample No. 112>

An electroconductive layer-transferring material of Sample No. 112 was produced in the same manner as in the production of Sample No. 101 except that the cushion layer was not formed between the base material and the electroconductive layer.

### <Electroconductive Layer-Transferring Material of Sample No. 113>

An electroconductive layer-transferring material of Sample No. 113 was produced in the same manner as in the production of Sample No. 101 except that the following ITO coating liquid was coated with a bar coater on the cushion layer and blown by hot air of 50° C. for drying to thereby form an electroconductive layer having an average thickness of 0.1 μm.

### —Preparation of ITO Coating Liquid—

Ethanol (300 parts by mass) was added to 100 parts by mass of ITO particles having primary particle diameters of 10 nm to 20 nm (product of MITSUI MINING & SMELTING CO., LTD., BET specific surface area: 30 m²/g). The resultant mixture was dispersed with a disperser using zirconia beads as media, to thereby prepare an ITO coating liquid.

### <Patterning Treatment>

The electroconductive layer and the cushion layer of each of the electroconductive layer-transferring materials were transferred to a transfer target (a glass substrate 0.7 mm in thickness). The transfer target was subjected to patterning treatment to thereby form striped patterns with line-and-space (hereinafter referred to as “L/S”)=100 μm/100 μm. The cushion layer is removed through showering development.

### [Patterning Conditions]

Through a mask, light exposure was performed using i-line of a high-pressure mercury lamp (365 nm) at 100 mJ/cm² (intensity of illumination: 20 mW/cm²). A developing liquid in which 5 g of sodium hydrogen carbonate and 2.5 g of sodium carbonate are dissolved in 5,000 g of pure water was showered on the exposed substrate for 30 sec. The showering pressure was set at 0.04 MPa. The time it took for the striped pattern to appear was 15 sec. Next, the resultant product was rinsed through showering of pure water.

### <Electroconductive Material of Sample No. 114>

The composition for a negative-type electroconductive layer of Sample No. 101 was coated through spin coating on a surface of a glass substrate having a thickness of 0.7 mm, followed by drying, to thereby form an electroconductive layer having an average thickness of 0.1 μm. In this manner, an electroconductive material of Sample No. 114 was produced.

Next, the electroconductive layer transferred or formed on the transfer target from each of Samples No. 101 to 114 was evaluated as follows in terms of light transmittance, surface resistance, in-plain uniformity of surface resistance, adhesiveness, presence of defects in the layer during transfer, and followability to concave/convex portions. The results are presented in Table 2.

### <Measurement of Light Transmittance>

Using Haze-Gard Plus (product of Gardner Co.), the electroconductive layer transferred or formed on the transfer target was measured for light transmittance at a measurement angle of 0° about the CIE luminosity function y under the C illuminant

### <Measurement of Surface Resistance>

The electroconductive layer transferred or formed on the transfer target was measured for surface resistance using a surface resistance meter (LORESTA-GP MCP-T600; product of Mitsubishi Chemical Corporation).

### <In-Plain Uniformity of Surface Resistance>

The in-plain uniformity of surface resistance of the electroconductive layer transferred or formed on the transfer target was evaluated using a surface resistance meter (LORESTA-GP MCP-T600; product of Mitsubishi Chemical Corporation). A sample (10 cm×10 cm) of the electroconductive layer transferred was placed on a grid paper sheet the squares of which are 5 mm×5 mm each. The surface resistance was measured at 12 points on the sample while a four-terminal probe was being moved. The thus-measured surface resistances were used to determine their average value Rav, maximum value Rmax and minimum value Rmin, from which ratio (Rmax/Rav) and ratio (Rmin/Rav) were calculated to evaluate in-plain uniformity of the surface resistance according to the following evaluation criteria.

### [Evaluation Criteria]

### A: Ratio (Rmax/Rav) or Ratio (Rmin/Rav) was 1.0.

### B: Ratio (Rmax/Rav) or Ratio (Rmin/Rav) was 1.0+0.1.

### C: Ratio (Rmax/Rav) or Ratio (Rmin/Rav) was 1.0+0.15.

### D: Ratio (Rmax/Rav) or Ratio (Rmin/Rav) was 1.0±0.5.

E: Ratio (Rmax/Rav) or Ratio (Rmin/Rav) was greater than 1.0±0.5
(problematic in practical use).

### <Evaluation of Adhesion>

The adhesiveness of the electroconductive layer transferred or formed on the transfer target was evaluated based on the cross-cut method (described in JIS-K5600-5-6). Specifically, a cross-cut guide (product of COTEC CORPORATION) was placed on the electroconductive layer transferred or formed on the transfer target, and the electroconductive layer was incised at intervals of 1 mm with a cutter knife. Then, a piece of adhesive tape was attached on the thus-incised layer and peeled off therefrom. According to the illustration described in JIS-K5600-5-6, the state of the layer remaining was ranked 6 levels of 0 to 5. The adhesiveness was evaluated according to the following evaluation criteria.

### [Evaluation Criteria]

A: State of the layer remaining was ranked 0.
B: State of the layer remaining was ranked 1.
C: State of the layer remaining was ranked 2 to 3.
D: State of the layer remaining was ranked 4 to 5.
<Evaluation of Presence of Defects in the Layer during Transfer>

Presence or absence of defects in the layer during transfer of the electroconductive layer to the transfer target was evaluated as follows. In order to visualize transferability, a blue electroconductive layer containing a copper phthalocyanine dye was used. The area (St) of the blue electroconductive layer transferred was divided by the area of the substrate (Ss) to calculate an area ratio (St/Ss), which was evaluated according to the following evaluation criteria.

### [Evaluation Criteria]

### A: 0.97≦Area Ratio≦1.0

### B: 0.95≦Area Ratio≦0.97

### C: 0.9≦Area Ratio≦0.95

### D: 0.8≦Area Ratio≦0.9

### E: Area Ratio<0.8

### <Followability to Concave/Convex Portions>

In order to evaluate followability to concave/convex portions, a concave/convex pattern was formed through photolithography on a glass substrate, the concave/convex pattern having 10 convex blocks made of a transparent resin (each block measuring 2.5 μm in height and 30 μm×30 μm) lined up in a row at intervals of 30 μm. In this pattern formation, light-exposing conditions and developing conditions were controlled to form two different test patterns: one containing blocks the cross-sections of the edges of which were substantially perpendicular to the glass substrate and the other containing blocks the cross-sections of the edges of which were sloped by about 2 μm (i.e., tapered away from the glass substrate). Then, Sample No. 101 was transferred on the glass substrate in the same manner as described above. This transfer was performed so that the concave/convex pattern was located at the center line of the electroconductive layer. After light-exposure and development, the concave and convex portions were observed under a microscope and evaluated according to the following evaluation criteria.

### [Evaluation Criteria]

A: No air bubbles were included even when the edges of the blocks were perpendicular.
B: No air bubbles were included when the edges of the blocks were sloped.
C: Air bubbles were included at two or less of the blocks the edges of which were perpendicular.
D: Air bubbles were included at two or less of the blocks the edges of which were sloped.
E: Air bubbles were included at two or more of the blocks regardless of their edge shape.

TABLE 2-1

| | | | Total thickness of | | | |
|---|---|---|---|---|---|---|
| | | | avg. thicknesses (a + b): A | | | |
| | Forming method of | | Avg. thickness of | Avg. thickness | | |
| | electroconductive | Avg. thickness of | electroconductive | of cushion | | |
| Sample No. | layer | base material: B | layer: a | layer: b | A/B | Notes |
| 101 | Transfer | 30 μm | 0.1 μm | 10 μm | 0.34 | Present |
| | | | | | | Invention |
| 102 | Transfer | 30 μm | 0.1 μm | 5 μm | 0.17 | Present |
| | | | | | | Invention |
| 103 | Transfer | 30 μm | 0.1 μm | 20 μm | 0.67 | Present |
| | | | | | | Invention |
| 104 | Transfer | 30 μm | 0.01 μm | 10 μm | 0.33 | Present |
| | | | | | | Invention |
| 105 | Transfer | 30 μm | 0.05 μm | 10 μm | 0.34 | Present |
| | | | | | | Invention |
| 106 | Transfer | 30 μm | 0.15 μm | 10 μm | 0.34 | Present |
| | | | | | | Invention |
| 107 | Transfer | 30 μm | 0.2 μm | 10 μm | 0.34 | Present |
| | | | | | | Invention |
| 108 | Transfer | 30 μm | 0.1 μm | 1 μm | 0.04 | Comp. Ex. |
| 109 | Transfer | 30 μm | 0.1 μm | 25 μm | 0.84 | Comp. Ex. |
| 110 | Transfer | 30 μm | 0.1 μm | 50 μm | 1.67 | Comp. Ex. |
| 111 | Transfer | 30 μm | 0.5 μm | 10 μm | 0.35 | Comp. Ex. |
| 112 | Transfer | 30 μm | 0.1 μm | — | 0.003 | Comp. Ex. |
| 113 | Transfer | 30 μm | 0.1 μm | 10 μm | 0.34 | Comp. Ex. |
| 114 | Spin coating | — | 0.1 μm | — | — | Comp. Ex. |

TABLE 2-2

| | | | In-plane | | Defects | | |
|---|---|---|---|---|---|---|---|
| | Light | Surface | uniformity of | | in layer | Followability to | |
| Sample | transmittance | resistance | surface | | during | concave and | |
| No. | (%) | (Ω/sq.) | resistance | Adhesiveness | transfer | convex portions | Notes |
| 101 | 91 | 50 | C | B | B | A | Present |
| | | | | | | | Invention |
| 102 | 91 | 50 | C | B | B | C | Present |
| | | | | | | | Invention |
| 103 | 91 | 50 | C | B | B | A | Present |
| | | | | | | | Invention |
| 104 | 92 | 200 | C | B | B | B | Present |
| | | | | | | | Invention |
| 105 | 92 | 100 | C | B | B | A | Present |
| | | | | | | | Invention |
| 106 | 89 | 30 | C | B | B | A | Present |
| | | | | | | | Invention |
| 107 | 85 | 20 | C | B | B | A | Present |
| | | | | | | | Invention |
| 108 | 91 | 50 | D | B | D | E | Comp. Ex. |
| 109 | 89 | 50 | C | B | C* | D | Comp. Ex. |
| 110 | 91 | 50 | C | B | C* | D | Comp. Ex. |
| 111 | 79 | 10 | C | B | B | D | Comp. Ex. |
| 112 | 91 | 50 | C | C | D | E | Comp. Ex. |
| 113 | 85 | 200 | C | C | D | E | Comp. Ex. |
| 114 | 89 | 100 | E | D | | — | Comp. Ex. |

*The electroconductive layer-transferring materials of Sample Nos. 109 and 110 were poor in curl balance and difficult to handle during transfer, so that defects occurred during transfer.

### Example 2

### Preparation of Electroconductive Layer Materials Having Different Changes in Resistance after Drawing

### —Electroconductive Layer Material of Sample No. 201—

The silver nanowire aqueous dispersion liquid of Preparation Example 2 was used to prepare a composition for a negative-type electroconductive layer similar to Sample No. 101. The thus-prepared composition for a negative-type electroconductive layer was coated through bar coat on a 100 μm-thick support of a polyethylene terephthalate (PET) resin so that the amount of the silver coated became 0.1 g/m². The support thusly coated with the composition was dried for 15 min in an oven set to 100° C. Next, the dried support was light-exposed and developed in the same manner as in Example 1 without being transferred to a glass substrate, to thereby prepare an electroconductive layer material of Sample No. 201.

### —Electroconductive Layer Material of Sample No. 202—

An electroconductive layer material of Sample No. 202 was prepared in the same manner as in the preparation of Sample No. 201 except that the silver nanowire aqueous dispersion liquid of Preparation Example 1 was used.

### (Samples No. 203 to No. 207)

The ratio between HTAB and OTAB, the amount of each of HTAB and OTAB, the heating time were appropriately adjusted in the preparation of the silver nanowire aqueous dispersion liquid of Preparation Example 2, to thereby prepare aqueous dispersion liquids of Preparation Examples 3 to 7 each containing silver nanowires adjusted in length. Specifically, the length of the silver nanowires was adjusted as follows: 33 μm in Preparation Example 3; 30 μm in Preparation Example 4; 27 μm in Preparation Example 5; 22 μm in Preparation Example 6; and 18 μm in Preparation Example 7.

Next, electroconductive layer materials of Samples No. 203 to No. 207 having different changes in resistance after drawing presented in Table 3 were prepared in the same manner as in the preparation of Sample No. 201 except that the silver nanowire aqueous dispersion liquid of Preparation Example 2 was changed to the silver nanowire aqueous dispersion liquids of Preparation Examples 3 to 7.

<Change in Resistance after Drawing at Draw Ratio of 2% or 5%>

Each of the electroconductive layer materials of Samples No. 201 to No. 207 and Sample No. 113 were pulled by a tension tester (A&D Company, Limited, TENSILON model RTC1325) so that the draw ratio became 2% or 5%. The resistances of each electroconductive layer before and after the pulling were measured using DIGITAL TESTER CDM-2000D (product of CUSTOM Co.). The change in resistance at a draw ratio of 2% or 5% was calculated from the following equation:

Change in resistance={(Resistance after pulling−Resistance before pulling)/Resistance before pulling}×100.

The results are presented in Table 3.

TABLE 3

| | Silver | Change in | Change in | |
|---|---|---|---|---|
| | nanowire | resistance (%) | resistance (%) | |
| Sam- | aqueous | after drawing at | after drawing at | |
| ple | dispersion | a draw ratio | a draw ratio | |
| No. | liquid | of 2% | of 5% | Notes |
| 201 | Preparation | 0.9 | 1.5 | Present |
| | Example 1 | | | Invention |
| 202 | Preparation | 66 | 200 | Present |
| | Example 2 | | | Invention |
| 203 | Preparation | 2.1 | 3 | Present |
| | Example 3 | | | Invention |
| 204 | Preparation | 3.5 | 15 | Present |
| | Example 4 | | | Invention |
| 205 | Preparation | 11 | 60 | Present |
| | Example 5 | | | Invention |
| 206 | Preparation | 25 | 150 | Present |
| | Example 6 | | | Invention |
| 207 | Preparation | 46 | 190 | Present |
| | Example 7 | | | Invention |
| 113 | ITO Coating | 220 | 900 | Comp. Ex. |
| | Liquid | | | |

### Example 3

Next, the silver nanowire aqueous dispersion liquids of Preparation Examples 1 to 7 were used to prepare electroconductive layer-transferring materials of Samples No. 211 to No. 217 in the same manner as in the preparation of Sample No. 101 of Example 1. Also, an electroconductive layer-transferring material of Sample No. 113 was provided for comparison.

### <Measurement of Change in Resistance of Eelectroconductive Layer Across Convex Portion>

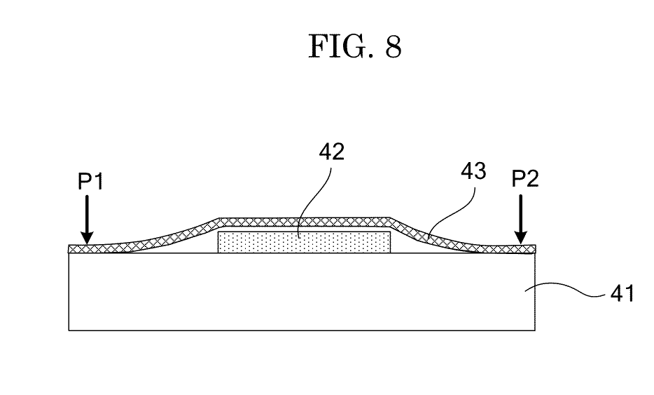

As illustrated in FIG. 8, each of the electroconductive layer-transferring materials was transferred so as to be across a transparent resin layer 42 (convex portion) 1 μm in height and 50 μm in width, which had been formed on a glass substrate 41 through photolithography. Then, the transferred electroconductive layer-transferring material was exposed to light and developed to form an electroconductive layer 43 having a width of 30 mm. The resistance of this electroconductive layer was measured at positions of P1 and P2 in FIG. 8 using DIGITAL TESTER CDM-2000D (product of CUSTOM Co.) (Resistance 1). Meanwhile, each electroconductive layer-transferring material was transferred onto a glass substrate on which no transparent resin layer was formed. The transferred electroconductive layer-transferring material was exposed to light and developed to form an electroconductive layer. The resistance of this electroconductive layer was measured using DIGITAL TESTER CDM-2000D (product of CUSTOM Co.) (Resistance 2). A change in resistance was calculated from the formula: {(Resistance 1−Resistance 2)/Resistance 2}×100. The change in resistance was calculated at a transfer speed of 0.5 cm/sec, 1 cm/sec, 2 cm/sec or 10 cm/sec. Each measurement is an average of 10 values measured 10 times. The results are presented in Table 4.

TABLE 4

| | | Transfer speed | | | | |
|---|---|---|---|---|---|---|
| Sample | | 0.5 | 1 | 2 | 10 | |
| No. | | cm/sec | cm/sec | cm/sec | cm/sec | Notes |
| 211 | Change in | 0% | 0% | 0% | 0% | Present |
| | resistance | | | | | Invention |
| 212 | | 26% | 26% | 52% | 85% | Present |
| | | | | | | Invention |
| 213 | | 0% | 0% | 0% | 6% | Present |
| | | | | | | Invention |
| 214 | | 0% | 0% | 0% | 12% | Present |
| | | | | | | Invention |
| 215 | | 0% | 0% | 6% | 21% | Present |
| | | | | | | Invention |
| 216 | | 0% | 0% | 14% | 45% | Present |
| | | | | | | Invention |
| 217 | | 0% | 0% | 34% | 68% | Present |
| | | | | | | Invention |
| 113 | | 45% | 60% | 90% | 150% | Comp. Ex. |

As is clear from Table 4, the electroconductive layer involving less change in resistance after drawing was found to involve less change in resistance when the electroconductive layer was across the convex portion on the glass substrate. Also, the change in resistance when the electroconductive layer was across the convex portion on the glass substrate became greater as the transfer speed was greater. It was found that there was a superior effect of reducing the change in resistance of the electroconductive layer after drawing. Therefore, it was found that the electroconductive layer involving less change in resistance after drawing was excellent in followability to concave/convex portions.

### Example 4

The amount of the binder (A-1) of Synthesis Example 1 and the amount of KAYARAD DPHA were changed in the preparation of Sample No. 211 in Example 3, to thereby prepare electroconductive layer-transferring materials of Sample No. 311 to Sample No. 317 the electroconductive layers of which having melt viscosities at 110° C. as presented in Table 5.

Notably, the melt viscosity at 110° C. of the electroconductive layer was measured in the following method.

Specifically, the coating liquid for forming an electroconductive layer was coated on a glass plate, followed by drying for about 2 min in an oven set to 100° C., to thereby form a dry film having a thickness of 15 μm. The formed film was further dried in vacuum at about 40° C. for about 6 hours. The degree of vacuum during drying in vacuum was 30 mmHg. After drying in vacuum, the film was peeled off from the glass plate and used as a sample. When the film could not be peeled off easily and successfully, it was scraped off and collected, and used as a sample. The melt viscosity was measured using a viscoelasticity measurement device DYNALYSER DAS-100 (product of Jasco International Co. Ltd) at a measurement temperature of 110° C. and a frequency of 1 Hz.

Each electroconductive layer-transferring material was measured in the same manner as in Example 3 for a change in resistance when the electroconductive layer was across the convex portion on the glass substrate. The results are presented in Table 5.

TABLE 5

| | Melt viscosity | | Transfer speed | | | | |
|---|---|---|---|---|---|---|---|
| Sample No. | (Pa · s) | | 0.5 cm/sec | 1 cm/sec | 2 cm/sec | 10 cm/sec | Notes |
| 311 | 500 | Change in | 15% | 22% | 30% | 40% | Present |
| | | resistance | | | | | Invention |
| 312 | 1,000 | | 3% | 5% | 7% | 10% | Present |
| | | | | | | | Invention |
| 313 | 2,000 | | 1% | 3% | 5% | 7% | Present |
| | | | | | | | Invention |
| 314 | 10,000 | | 0% | 0% | 0% | 0% | Present |
| | | | | | | | Invention |
| 315 | 100,000 | | 0% | 0% | 0% | 0% | Present |
| | | | | | | | Invention |
| 316 | 1,000,000 | | 0% | 0% | 0% | 0% | Present |
| | | | | | | | Invention |
| 317 | 2,000,000 | | 0% | 0% | 10% | 20% | Present |
| | | | | | | | Invention |

As is clear from Table 5, the change in resistance when the electroconductive layer was across the convex portion on the glass substrate was small when the melt viscosity at 110° C. of the electroconductive layer was 1,000 Pa·s to 1,000,000 Pa·s.

### Example 5

### Production of Touch Panel

Touch panels were produced using the electroconductive layer-transferring material of Sample No. 101 by a known method described in, for example, “Latest Touch Panel Technology (Saishin Touch Panel Gijutsu)” (published on Jul. 6, 2009 from Techno Times Co.), supervised by Yuji Mitani, “Development and Technology of Touch Panel (Touch Panel no Gijustu to Kaihatsu),” published from CMC (December, 2004), “FPD International 2009 Forum T-11 Lecture Text Book,” and “Cypress Semiconductor Corporation Application Note AN2292.”

By virtue of improvement in transmittance, it was found that touch panels produced therefrom were excellent in visibility. In addition, by virtue of improvement in electroconductivity, it was also found that touch panels produced therefrom were excellent in response to input of, for example, characters or screen touch with at least one of a bare hand, a hand wearing a glove and a pointing tool.

### INDUSTRIAL APPLICABILITY

The electroconductive layer-transferring material of the present invention can widely be used for a touch panel, an antistatic display film, an electromagnetic shield, an organic EL display electrode, an inorganic EL display electrode, electronic paper, a flexible display electrode, an antistatic flexible display film, a solar battery, and other various devices.

What is claimed is:

1. An electroconductive layer-transferring material comprising:
a base material;
a cushion layer on the base material; and
an electroconductive layer on the cushion layer,
the electroconductive layer containing metal nanowires having an average minor axis length of 100 nm or less and an average major axis length of 2 μm or more,
wherein the electroconductive layer-transferring material satisfies A/B=0.1 to 0.7, where A is a total thickness of an average thickness of the electroconductive layer and an average thickness of the cushion layer, and B is an average thickness of the base material,
wherein the average thickness of the electroconductive layer is 0.01 μm to 0.2 μm, and
wherein the average thickness of the cushion layer is 1 μm to 50 μm.

2. The electroconductive layer-transferring material according to claim 1, wherein the average thickness of the electroconductive layer is 0.05 μm to 0.15 μm.

3. The electroconductive layer-transferring material according to claim 1, wherein the average thickness of the cushion layer is 5 μm to 20 μm.

4. The electroconductive layer-transferring material according to claim 1, wherein the electroconductive layer has a change in resistance of 0% to 50%, where the change in resistance is calculated by {(Y−X)/X}×100 where X is a resistance of the electroconductive layer before drawing of the electroconductive layer and Y is a resistance of the electroconductive layer after tensile drawing of the electroconductive layer in a horizontal direction at a draw ratio of 2%.

5. The electroconductive layer-transferring material according to claim 1, wherein the electroconductive layer has a change in resistance of 0% to 100%, where the change in resistance is calculated by {(Z−X)/X}×100 where X is a resistance of the electroconductive layer before drawing of the electroconductive layer and Z is a resistance of the electroconductive layer after tensile drawing of the electroconductive layer in a horizontal direction at a draw ratio of 5%.

6. The electroconductive layer-transferring material according to claim 1, wherein the electroconductive layer has a melt viscosity at 110° C. of 500 Pa·s to 2,000,000 Pa·s.

7. The electroconductive layer-transferring material according to claim 6, wherein the electroconductive layer has a melt viscosity at 110° C. of 1,000 Pa·s to 1,000,000 Pa·s.

8. The electroconductive layer-transferring material according to claim 1, wherein the electroconductive layer has a mass ratio a/b of 0.1 to 5, where “a” is a mass of other ingredients than the metal nanowires in the electroconductive layer and “b” is a mass of the metal nanowires in the electroconductive layer.

9. The electroconductive layer-transferring material according to claim 1, wherein the metal nanowires are formed of silver or formed of an alloy formed between silver and a metal other than silver.

10. The electroconductive layer-transferring material according to claim 1, wherein the electroconductive layer has a total visible light transmittance of 85% or more.

11. The electroconductive layer-transferring material according to claim 1, wherein the electroconductive layer has a surface resistance of 0.1 Ω/sq. to 5,000 Ω/sq.

12. The electroconductive layer-transferring material according to claim 1, further comprising an adhesion layer on the electroconductive layer.

13. A liquid crystal display device or a touch panel comprising:
an electroconductive layer,
wherein the electroconductive layer is transferred from an electroconductive layer-transferring material, and the electroconductive layer-transferring material comprises:
a base material;
a cushion layer on the base material; and
the electroconductive layer on the cushion layer,
the electroconductive layer containing metal nanowires having an average minor axis length of 100 nm or less and an average major axis length of 2 μm or more,
wherein the electroconductive layer-transferring material satisfies A/B=0.1 to 0.7, where A is a total thickness of an average thickness of the electroconductive layer and an average thickness of the cushion layer, and B is an average thickness of the base material,
wherein the average thickness of the electroconductive layer is 0.01 μm to 0.2 μm, and
wherein the average thickness of the cushion layer is 1 μm to 50 μm.

14. A method for transferring an electroconductive layer, the method comprising:
transferring an electroconductive layer of an electroconductive layer-transferring material to a transfer target having concave and convex portions at a transfer speed of 0.5 cm/sec to 10 cm/sec,
wherein the electroconductive layer-transferring material comprises:
a base material;
a cushion layer on the base material; and
the electroconductive layer on the cushion layer,
the electroconductive layer containing metal nanowires having an average minor axis length of 100 nm or less and an average major axis length of 2 μm or more,
wherein the electroconductive layer-transferring material satisfies A/B=0.1 to 0.7, where A is a total thickness of an average thickness of the electroconductive layer and an average thickness of the cushion layer, and B is an average thickness of the base material,
wherein the average thickness of the electroconductive layer is 0.01 μm to 0.2 μm, and
wherein the average thickness of the cushion layer is 1 μm to 50 μm.
